(19) United States
(12) Patent Application Publication
(10) Pub. No.: US 2026/0277579 A1
(43) Pub. Date: Sep. 17, 2026

(54) DEPLOYING AUTONOMOUS SOFTWARE AGENTS WITH REUSABLE SYSTEM PROMPTS

(71) Applicant: COGNITION AI, INC., San Francisco, CA (US)

(72) Inventors: Tony Jiang, Sunnyvale, CA (US); Scott Wu, Atherton, CA (US); Steven Hao, Atherton, CA (US); Sampriti Panda, Menlo Park, CA (US); Walden Yan, Atherton, CA (US); Adhyyan Sekhsaria, San Francisco, CA (US); Jeffrey Ling, Redwood City, CA (US); Moritz Stephan, San Francisco, CA (US)

(21) Appl. No.: 19/561,219

(22) Filed: Mar. 9, 2026

Related U.S. Application Data
(60) Provisional application No. 63/770,816, filed on Mar. 12, 2025.

(51) Int. Cl. G06F 8/61

(52) U.S. Cl. CPC G06F 8/61

(57) ABSTRACT

The present disclosure relates to systems, methods, and non-transitory computer-readable media that deploys an autonomous software agent to execute a software task responsive to a system prompt. In particular, the disclosed systems provide a playbook library that includes a plurality of reusable system prompts. Moreover, the disclosed systems receive a system prompt selected from the plurality of reusable system prompts. Additionally, the disclosed systems deploys an autonomous software agent, which operates within an independent virtual machine computing environment, to execute a software task responsive to the system prompt selected from the playbook library.

### CROSS REFERENCE TO RELATED APPLICATIONS

This application claims the benefit of and priority to U.S. Provisional Application No. 63/770,816, filed Mar. 12, 2025. The aforementioned application is hereby incorporated by reference in its entirety.

### BACKGROUND

Advancements in computing devices and networking technology have given rise to a variety of innovations in machine learning and digital co-pilot assistants. Over time, computing systems have been developed that generate computer code to assist (e.g., in a co-pilot like manner) a software developer in completing their computer tasks. For instance, some existing systems can assist software developers in generating code by supplementing computer code or making tweaks to existing computer code. Despite these advances, however, existing systems continue to suffer from a number of disadvantages, particularly in terms of computational efficiency, technical accuracy, and operational flexibility.

### SUMMARY

One or more embodiments described herein provide benefits and/or solve one or more problems in the art with systems, methods, and non-transitory computer-readable media that deploy an autonomous software agent and execute software tasks based on receiving a system prompt. To illustrate, in one or more embodiments, the disclosed systems provide a playbook library via a graphical user interface, where the playbook library contains a plurality of reusable system prompts. Further, in one or more embodiments, the disclosed systems receive a selection of the system prompt from the plurality of reusable system prompts. Moreover, in one or more embodiments, the disclosed systems utilize an autonomous software agent to execute a software task (e.g., generate computer code, create an application end-to-end, fine-tune an artificial intelligence model, debug computer code, etc.) responsive to the system prompt selected from the playbook library.

Additional features and advantages of one or more embodiments of the present disclosure are outlined in the description which follows, and in part will be obvious from the description, or may be learned by the practice of such example embodiments.

### BRIEF DESCRIPTION OF THE DRAWINGS

This disclosure will describe one or more embodiments of the invention with additional specificity and detail by referencing the accompanying figures. The following paragraphs briefly describe those figures, in which:

FIG. 1 illustrates an overview diagram of an autonomous software agent system receiving a selection of a system prompt and deploying an autonomous software agent in response to the selection of the system prompt in accordance with one or more implementations;

FIG. 2 illustrates an example diagram of the autonomous software agent system receiving a selection to create a new system prompt in accordance with one or more implementations;

FIG. 3 illustrates an example diagram of the autonomous software agent system utilizing an autonomous software agent to access a plurality of software composition tools in accordance with one or more implementations;

FIG. 4 illustrates an example diagram of the autonomous software agent system receiving a selection of a system prompt in accordance with one or more implementations;

FIGS. 5A-5B illustrate example graphical user interfaces of the autonomous software agent system providing options to create a new system prompt and selecting the new system prompt in accordance with one or more implementations;

FIG. 6 illustrates an example diagram of the autonomous software agent system deploying multiple autonomous software agents according to a system prompt to execute the system prompt in different software contexts in accordance with one or more implementations;

FIGS. 7-8 illustrate example graphical user interfaces of the autonomous software agent system receiving a selection and modification of a system prompt in accordance with one or more embodiments;

FIG. 9 illustrates an example graphical user interface of the autonomous software agent system receiving a selection to edit a system prompt in accordance with one or more embodiments;

FIG. 10 illustrates an example diagram of an architectural layer design of the autonomous software agent system which accesses various artificial intelligence models to enable an independent virtual machine computing environment of an autonomous software agent in accordance with one or more implementations;

FIG. 11 illustrates an example diagram of a virtual private cloud housing an independent virtual machine computing environment that is in communication with an autonomous agent model backend in accordance with one or more implementations;

FIG. 12 illustrates an example diagram of a frontend layer interacting with an autonomous software agent system ingestion layer and a virtual private cloud in accordance with one or more implementations;

FIG. 13 illustrates an example environment of the autonomous software agent system in accordance with one or more implementations;

FIG. 14 illustrates an example series of acts for deploying an autonomous software agent to execute a software task responsive to a system prompt in accordance with one or more implementations;

FIG. 15 illustrates an example series of acts for deploying multiple autonomous software agents to execute one or more software tasks each in a different context in accordance with one or more implementations; and

FIG. 16 illustrates a block diagram of an exemplary computing device in accordance with one or more implementations.

### DETAILED DESCRIPTION

One or more embodiments described herein includes an autonomous software agent system that provides a playbook library of reusable system prompts to a user computing device to deploy autonomous software agents to execute repeatable tasks in unique software contexts. To illustrate, in one or more embodiments, an autonomous software agent system provides a library of system prompts that are repeatable across different types of development sessions. In some embodiments, the autonomous software agent system receives a selection of a system prompt from a library of reusable system prompts and deploys an autonomous software agent according to the selected system prompt. As an example, the autonomous software agent system provides system prompts for development sessions that integrate third-party libraries within different contexts/parts of a software application.

In one or more embodiments, the autonomous software agent system deploys an autonomous software agent to independently complete software development tasks such as writing computer code tests, adding features to an existing code repository, adding functionality to an existing codebase, developing prototypes, and building integrations between software applications. In one or more embodiments, the autonomous software agent system provides the library of system prompts for a user computing device to streamline the efficiency and accuracy of autonomous software agents executing non-trivial software tasks. In some instances, the autonomous software agent system provides options for a user computing device to create new system prompts.

In one or more embodiments, the autonomous software agent system provides an option for a user computing device to deploy multiple autonomous software agents. For example, the autonomous software agent system can receive a selection of a system prompt from a playbook library and deploy the multiple autonomous software agents according to the selected system prompt. In particular, the autonomous software agent system can deploy multiple autonomous software agents, where each autonomous software agent executes software tasks in a different context responsive to the selected system prompt.

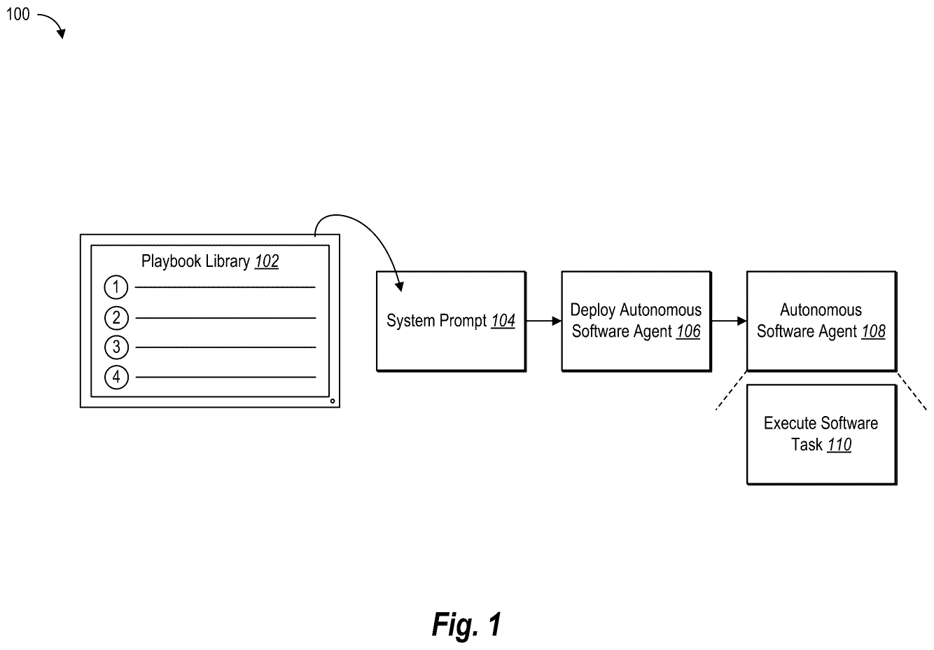

FIG. 1 illustrates an overview diagram of the autonomous software agent system 100 receiving a selection of a system prompt from a playbook library in accordance with one or more embodiments. For example, FIG. 1 shows the autonomous software agent system 100 providing a playbook library 102 to a graphical user interface of a user computing device.

In one or more embodiments, the playbook library 102 refers to a library of reusable prompts that are customized to various use cases of an entity/organization corresponding to the user computing device. For example, the playbook library 102 refers to a library that stores a plurality of system prompts that are easily shareable and reusable for repeatable tasks (e.g., to replicate in different software contexts). For instance, the autonomous software agent system 100 stores system prompts within the playbook library 102 in response to a user computing device creating new playbooks and/or in response to the autonomous software agent system 100 prompting a user computing device to save an action as a system prompt within the playbook library 102.

In one or more embodiments, a “playbook” (also referred to herein as a reusable system prompt) refers to a structured, executable instruction set that encodes one or more software tasks in a reusable, parameterizable, and context-adaptable format. A playbook comprises machine-interpretable content that defines how an autonomous software agent should perform a defined objective within an independent virtual machine computing environment.

In one or more embodiments, a playbook includes one or more of: (i) a procedure section comprising ordered procedural steps written in imperative form; (ii) a specifications section defining post conditions, required outputs, validation criteria, or correctness constraints; (iii) a parameter definition section specifying required or optional input variables, default values, data types, and validation rules; (iv) an advice section containing optimization guidance or corrective heuristics; (v) a forbidden actions section defining execution constraints or hard boundaries; and (vi) a dependency declaration section identifying runtime requirements, environment configurations, or tool capabilities.

In one or more embodiments, a playbook is stored as a structured data object comprising executable metadata and content fields. The structured data object may be represented in a serialized format including, without limitation, JSON, YAML, XML, or other machine-readable schema. A playbook may further include a unique identifier, version information, author metadata, lifecycle state indicators, permission attributes, and semantic embedding representations to enable search, recommendation, and similarity comparison within a playbook library.

In one or more embodiments, a playbook differs from an ad hoc natural language prompt in that a playbook is persistently stored, version-controlled, parameterizable, and executable across multiple development sessions and execution contexts. For example, a playbook is designed to encode repeatable workflows such that an autonomous software agent may deterministically instantiate, execute, validate, and, if necessary, iteratively refine the defined software task according to the structured contents of the playbook.

In some embodiments, execution of a playbook comprises binding parameter values, initializing an independent virtual machine computing environment that satisfies declared dependencies, generating an artificial intelligence plan using a planner tool, and orchestrating coordinated interactions among a shell tool, browser tool, integrated development environment, and one or more machine learning models until defined post conditions are satisfied.

As shown in FIG. 1, the autonomous software agent system 100 receives a selection of a system prompt 104 from the playbook library 102. In one or more embodiments, the system prompt 104 refers to a natural language prompt (selected from the playbook library 102) that can contain other modalities (e.g., image or video). In one or more embodiments, the system prompt 104 refers to a request, a question, or an instruction saved within the playbook library 102 (e.g., submitted by a user of a user account corresponding to a user computing device).

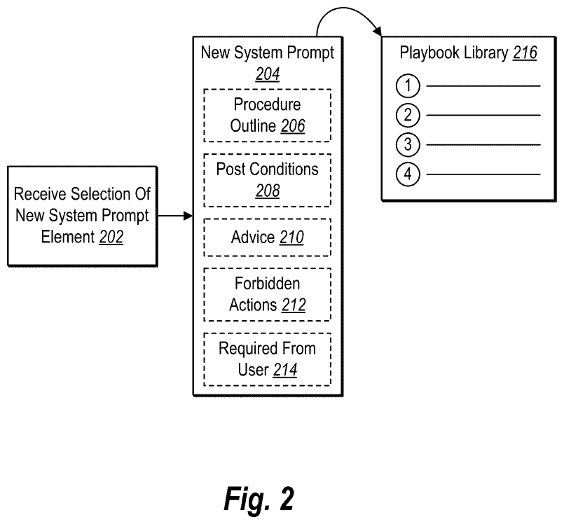

Moreover, in some embodiments, the system prompt 104 includes generalizable elements (e.g., placeholders for variable input). In other words, the system prompt 104 includes elements that vary within different software contexts, such that the autonomous software agent system 100 can swap in new content for the generalizable elements without rewriting the system prompt 104. Furthermore, in some embodiments, the system prompt 104 includes a defined output format and optional constraints. Specific details relating to the contents of the system prompt 104 are given below in the description of FIG. 2.

FIG. 1 shows the autonomous software agent system 100 receiving the system prompt 104, and the autonomous software agent system 100 performs an act 106 of deploying an autonomous software agent 108. In one or more embodiments, the autonomous software agent system 100 deploys the autonomous software agent 108 (e.g., a cloned virtual machine that is isolated and can perform tasks siloed from other virtual machine computing devices). In particular, the autonomous software agent system 100 deploys the autonomous software agent 108 within an independent virtual machine computing environment and generates and runs code in its own isolated environment.

In one or more embodiments, the independent virtual machine computing environment refers to a software-based simulation that independently runs its own operating system and applications as a standalone machine. For example, a virtual machine computing environment refers to a software-implemented computational environment that emulates a physical computing system and provides an isolated, executable runtime environment for code generation, execution, testing, modification, or orchestration by the autonomous software agent system 100. In one or more embodiments, the virtual machine computing environment may operate as a system-level virtualization layer (e.g., hypervisor-based virtual machine), an operating system-level container, a language runtime virtual machine, or a custom execution sandbox, and may be dynamically provisioned, configured, and decommissioned under control of the virtual machine computing environment. Thus, a deployed autonomous software agent independently leverages its own independent computing environment.

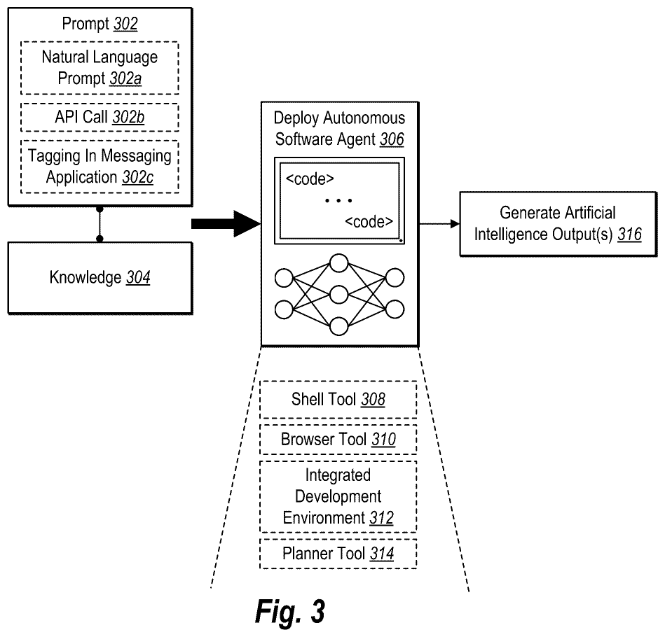

In other words, the autonomous software agent 108 exists independently of a computing device of a user who submitted a prompt to deploy the autonomous software agent 108 and performs tasks based on knowledge that is provided to it. Moreover, the autonomous software agent system 100 further provides to the autonomous software agent 108 computer software composition tools. Details pertaining to the computer software composition tools are given in more detail below in the description of FIG. 3.

In one or more embodiments, the autonomous software agent system 100 provides the autonomous software agent 108 with its own software development environment (e.g., the independent virtual machine computing environment with access to the computer software composition tools) to perform individualized tasks and not merely supplementary tasks (e.g., the autonomous software agent can deploy its own codebase by replicating an existing codebase, make changes to an existing codebase, implement changes to a codebase, and run tests for computer code generated by an autonomous software agent).

In some embodiments, the autonomous software agent 108 includes a set of artificial intelligence models. In particular, the autonomous software agent 108 includes one or more machine learning models, neural networks, large language models, chain-of-thought reasoning models, and/or vision-language models. Thus, the autonomous software agent system 100 deploys an autonomous software agent that operates within an independent virtual machine computing device with various machine learning components used to analyze, process, and generate information.

In one or more embodiments, a machine learning model includes a computer algorithm or a collection of computer algorithms that can be trained and/or tuned based on inputs to approximate unknown functions. For example, a machine learning model can include a computer algorithm with branches, weights, or parameters that change based on training data to improve for a particular task. Thus, a machine learning model can utilize one or more learning techniques to improve in accuracy and/or effectiveness. Example machine learning models include various types of decision trees, support vector machines, Bayesian networks, random forest models, or neural networks (e.g., deep neural networks).

Similarly, a neural network includes a machine learning model of interconnected artificial neurons (e.g., organized in layers) that communicate and learn to approximate complex functions and generate outputs based on a plurality of inputs provided to the model. In some instances, a neural network includes an algorithm (or set of algorithms) that implements deep learning techniques that utilize a set of algorithms to model high-level abstractions in data. To illustrate, in some embodiments, a neural network includes a convolutional neural network, a recurrent neural network (e.g., a long short-term memory neural network), a transformer neural network, a generative adversarial neural network, a graph neural network, a diffusion neural network, a multi-layer perceptron, a large language model (LLM), a generative pre-trained transformer model (GPT), a chain-of-thought machine learning model, etc. In some embodiments, a neural network includes a combination of neural networks or neural network components.

In one or more embodiments, a language model includes a set of statistical or probabilistic functions to perform Natural Language Processing (NLP) in order to understand, learn, and/or generate human natural language content. For example, the autonomous software agent system 100 uses a language model as a tool that determines the probability of a given sequence of words occurring in a sentence or natural language sequence. Simply put, the autonomous software agent system 100 uses a model that is trained to predict the next word in a sentence.

A language model is called a large language model (LLM) when it is trained on an enormous amount of data (e.g., a threshold amount of data) and/or has a large number of parameters. These models have capabilities ranging from writing a simple essay to generating complex computer codes-all with limited to no supervision. Accordingly, an LLM can comprise a deep neural network that is very large (billions to hundreds of billions of parameters) and understands, processes, and produces human natural language by being trained on massive amounts of text.

These models predict future words in a sentence letting them generate sentences similar to how humans talk and write or otherwise in a form dictated, for instance, by a prompt. In one or more implementations, an LLM utilized by the autonomous software agent system 100 employs a “chain-of-thought” reasoning approach that allows the model to internally deliberate before providing responses. Indeed, one or more implementations include an LLM trained using reinforcement learning techniques that enable the LLM to refine its reasoning skills through iterative feedback.

In one or more embodiments, a playbook includes deterministic execution parameters comprising LLM selection constraints, temperature settings, random seed values, and output formatting specifications. The autonomous software agent system 100 binds the specified deterministic parameters to large language model invocations to ensure reproducible execution behavior across multiple development sessions. In some embodiments, execution transcripts and model configuration parameters are stored as part of session metadata to enable full replay and auditability.

Additionally, FIG. 1 shows the autonomous software agent system 100 utilizing the autonomous software agent 108 to execute a software task 110. In one or more embodiments, the software task 110 refers to a defined unit of work in a software project to be planned, assigned, executed and/or completed. For example, the software task 110 refers to a specific software component for the autonomous software agent system 100 to build, change, fix, and/or maintain based on requirements of the system prompt 104. In other words, the software task 110 refers to a discrete, actionable piece of work that contributes to the development, maintenance, or improvement of a software system. More specifically, a software task refers to a defined computational objective, instruction set, or problem specification that can be satisfied through the generation, modification, execution, analysis, or orchestration of computer-executable code by an artificial intelligence (AI) code-writing agent.

A software task may be expressed in natural language, structured prompts, formal specifications, source code fragments, test cases, API definitions, configuration files, user stories, or any combination thereof. In one or more embodiments, a software task defines one or more functional, logical, structural, or performance requirements that constrain or guide code generation or transformation. For example, a software task may include, without limitation: generating source code implementing specified functionality; translating code between programming languages or frameworks; completing partial code segments; refactoring, optimizing, or modifying existing code; debugging code based on error messages, stack traces, or failing tests; generating unit tests, integration tests, or documentation; constructing data pipelines, scripts, or infrastructure definitions; performing static or dynamic analysis and producing corrective modifications; or orchestrating multi-step development workflows involving code synthesis and validation.

In one or more embodiments, a software task may further include associated constraints such as target programming language, runtime environment, library dependencies, security policies, performance thresholds, coding standards, or interface requirements. In some embodiments, a software task may be decomposed into subtasks, iteratively refined, validated against automated test harnesses, or dynamically modified based on intermediate execution results. The autonomous software agent system 100 may autonomously interpret, prioritize, sequence, and execute one or more software tasks within a broader development objective. Unless expressly limited, a software task encompasses any machine-interpretable or human-specified objective that can be fulfilled, in whole or in part, through automated code generation or code manipulation.

As mentioned above, existing systems are inefficient. For example, existing systems provide code generation assistant features to assist a developer in completing their software tasks. However, these existing systems merely supplement developer work. In particular, existing systems require heavily involved guidance, prompting, monitoring, and the use of a developer's device in order to supplement developer work. In other words, existing systems merely act as a co-pilot to a developer. Accordingly, existing systems suffer from computational inefficiencies of attempting to integrate a code development assistant into a developer's workflow and often suffer from being prompted and re-prompted to yield satisfactory results (e.g., which results in wasted computational resources).

In addition to their inefficiency issues, existing systems are also inaccurate. More particularly, due to the standard paradigm of existing systems supplementing code development, existing systems are often incomplete or inadequate in generating complex and extensive computer code. Moreover, existing systems often supplement code development efforts but generate computer code that inaccurately addresses an intent (expressed by an input prompt) and/or that is operationally invalid, including syntactic errors, semantic errors, and/or logical errors.

In particular, existing systems may be able to generate computer code to supplement a developer's task, however it is often difficult or impossible to follow/understand the thought process of existing code generation systems when writing computer code. Often, existing code generation systems are a black box that receive instructions and output computer code (e.g., which results in difficulties in understanding how the existing code generation system arrived at its answer). As such, modifying intermediate steps of a (supplementary) software coding task performed by existing code generation systems is often infeasible.

Relatedly, existing systems suffer from operational inflexibility. Because existing systems are limited to supplementing code development for cases expressly coded by engineers, these existing systems fail to adapt to creating new computer code, tackling complex non-trivial tasks, correctly understanding already generated computer code and/or effectively performing tests on computer code. Indeed, the inflexible nature of existing systems severely hampers the ability of existing systems to keep up with the taxing demands of software development from a holistic perspective. In other words, existing systems are stuck operating as a co-pilot developer to merely supplement a software developer's workflow.

In one or more embodiments, the autonomous software agent system 100 provides several improvements over conventional systems in relation to technical accuracy, computational efficiency, and operational flexibility. In contrast to existing systems, which require heavily involved guidance, prompting, monitoring, and the use of a developer's device (in order to supplement developer work), the autonomous software agent system 100 deploys an autonomous software agent that operates as an independent virtual machine computing device.

In doing so, the autonomous software agent system 100 allows for an autonomous software agent to operate independently to solve non-trivial tasks, and it does not conflate or confuse the context of other ongoing tasks. Specifically, the autonomous software agent system 100 silos/isolates autonomous software agents (e.g., to operate independently with fully featured computer software composition tools discussed in more detail in FIG. 3) such that the autonomous software agents can accurately perform their assigned software tasks without being bogged down by additional information.

In one or more embodiments, the autonomous software agent system 100 further improves upon technical inaccuracies by leveraging system prompts stored within a playbook library. For example, the autonomous software agent system 100 provides a playbook library to a user computing device for the user computing device to select one or more reusable system prompts. In doing so, the autonomous software agent system 100 can respond to selected system prompts, which improves the success of executing software tasks, as reusable system prompts are often tested and proven to yield satisfactory results (e.g., improving the technical accuracy of executing the software task).

In one or more embodiments, the autonomous software agent system 100 further improves upon technical inaccuracies. In contrast to existing systems, which are often incomplete or inadequate in generating complex and extensive computer code, the autonomous software agent system 100 deploys an autonomous software agent that uses an intelligent orchestration process to determine how to understand a relevant code repository/environment, how to generate artificial intelligence outputs (e.g., computer code) that match a determined context, and how to choose between various artificial intelligence models to accomplish various software tasks.

In some embodiments, the autonomous software agent system 100 allows a user of a computing device to configure an autonomous software agent environment (e.g., via a system prompt selected from a playbook library) and then deploys the autonomous software agent to complete a software task, thus improving the technical accuracy of artificial intelligence agents performing software tasks (e.g., relative to existing systems).

In one or more embodiments, the autonomous software agent system 100 enables a user computing device to follow the work of an autonomous software agent as it performs a software coding task within a web browser application of the autonomous software agent system 100. For example, the autonomous software agent system 100 displays commands submitted by the autonomous software agent via a terminal, computer code being written by the autonomous software agent via an editor, and computer code being debugged by the autonomous software agent. As such, the autonomous software agent system 100 enables a user of a computing device to more accurately understand the manner in which an autonomous software agent arrived at a final result (e.g., the user computing device can follow the autonomous software agent in real-time).

Relatedly, the autonomous software agent system 100 also improves computational efficiency of software tasks by enabling options for a user computing device to follow an autonomous software agent executing a software task. In particular, as mentioned, the autonomous software agent can operate independently, and in some instances, a user can intervene or understand the steps/thought processes of an autonomous software agent by following the autonomous software agent as it switches between using different computer software composition tools.

In particular, a user of a computing device can follow an autonomous software agent as it switches between different computer software composition tools to execute a software task. In doing so, the autonomous software agent system 100 saves computational resources and time as a user can more efficiently understand the process of an autonomous software agent (e.g., as it performs a task or after it performs a task) and the user can intervene at one or more points in the development session to aid/assist an autonomous software agent.

In one or more embodiments, the autonomous software agent system 100 improves computational efficiency by providing a library of reusable prompts for selection from a user computing device. In particular, the autonomous software agent system 100 provides the library of reusable prompts which conserves the time and resources of user computing devices as they do not have to create prompts from the ground up. In other words, the autonomous software agent system 100 stores reusable system prompts that are deployable within different software contexts to improve the computational efficiency of autonomous software agents.

Furthermore, the autonomous software agent system 100 improves computational efficiency by enabling a user computing device to continue to delegate entire non-trivial software coding tasks to the autonomous software agent while the autonomous software agent is already working completely asynchronously. As the autonomous software agent is executing a software coding task, a user can delegate multiple additional autonomous software agents to perform additional software tasks. Thus, the autonomous software agent system 100 enables large scale parallelization of tasks.

Relatedly, the autonomous software agent system 100 allows a user computing device to deploy multiple autonomous software agents to execute a system prompt within many different software contexts. Accordingly, the autonomous software agent system 100 can effectively accomplish non-trivial software tasks based on a selection of a system prompt from a playbook library.

In one or more embodiments, the autonomous software agent system 100 further improves upon operational inflexibilities. In contrast to existing systems, which are rigidly tied to code supplementation, the autonomous software agent system 100 deploys an autonomous software agent that operates within an independent virtual machine computing environment and further allows a user to monitor/modify the progress of the autonomous software agent (if so desired). Moreover, because the autonomous software agent system 100 deploys an autonomous software agent that is provided with various development box tools, the autonomous software agent acts as an advanced reasoning tool to complete non-trivial tasks. Accordingly, the autonomous software agent system 100 enhances the flexibility of operations in performing code generation tasks relative to existing systems.

FIG. 2 illustrates the autonomous software agent system 100 creating a new system prompt in accordance with one or more embodiments. For example, FIG. 2 shows the autonomous software agent system 100 performing an act 202 of receiving a selection of a new system prompt element. In particular, the new system prompt element refers to a graphical user interface element for a user computing device to manifest their intent of creating a new system prompt.

As shown in FIG. 2, in response to the selection of the new system prompt, the autonomous software agent system 100 generates/creates a new system prompt 204. In particular, the new system prompt 204 refers to a system prompt that is new relative to system prompts already stored within a playbook library 216. Furthermore, FIG. 2 shows that in some embodiments, the new system prompt 204 includes a procedure outline 206, post conditions 208, advice 210, forbidden actions 212, and information required from a user 214.

In one or more embodiments, the procedure outline 206 refers to a scope of a software task. In particular, the procedure outline 206 includes a setup step, a task description, and an expected output/delivery from following the procedure outline 206. In particular, the procedure outline 206 refers to a step-by-step summary of how a software task should be performed and describes the sequence of actions (e.g., collect input, analyze data, and produce output).

In one or more embodiments, the post conditions 208 refer to states or requirements following the execution of a system prompt. For example, the post conditions 208 define the state that must be true after a procedure is completed. In other words, the post conditions 208 define the expected results. In one or more embodiments, the advice 210 refers to tips to correct prior actions by the autonomous software agent system 100. In particular, the advice 210 refers to optimal recommendations or best practices that improve outcomes.

In one or more embodiments, the forbidden actions 212 refer to any actions that the autonomous software agent system 100 absolutely should not perform. In other words, the forbidden actions 212 refer to express actions that must not be taken under any circumstances (e.g., hard boundaries). In one or more embodiments, the information required from a user 214 refers to any inputs or information required to be submitted by a user computing device to properly execute the system prompt. In particular, the information required from a user 214 refers to inputs that a user must provide before or during a procedure being executed by the autonomous software agent system 100.

As shown in FIG. 2, the autonomous software agent system 100 generates the new system prompt 204 and stores the new system prompt 204 within the playbook library 216. Accordingly, the autonomous software agent system 100 generates the new system prompt 204 (e.g., based on user input from a user computing device) and stores the new system prompt 204 within the playbook library 216 for future selection within a future or current development session.

In one or more embodiments, each reusable system prompt (e.g., playbook) stored within the playbook library 216 is associated with structured metadata. The structured metadata includes a unique playbook identifier, a version identifier, a creation timestamp, a last-modified timestamp, an author identifier, a tenant identifier, one or more categorical tags, and a usage count. In some embodiments, the structured metadata further includes a semantic embedding vector representation of the playbook to enable similarity search, recommendation, and threshold overlap detection within a shared embedding space.

In one or more embodiments, the autonomous software agent system 100 maintains a version-controlled history of each playbook. Each modification to a playbook results in creation of a new immutable version record linked to a prior version via a version chain identifier. In some embodiments, the system stores differential change data between versions to enable version comparison and rollback. A graphical user interface may provide options to restore a prior version, compare two versions, or branch a new playbook from an existing version. This version-controlled architecture enables reproducibility of software task execution across development sessions.

In one or more embodiments, a playbook is associated with one or more lifecycle states comprising draft, published, deprecated, archived, and deleted states. The autonomous software agent system 100 enforces state-based constraints such that only published playbooks are executable, deprecated playbooks generate warning indicators, archived playbooks are hidden from default search results, and deleted playbooks are soft-deleted and recoverable within a threshold retention period.

In some embodiments, the autonomous software agent system 100 receives a selection of the new system prompt 204 and receives guidance instructions. In one or more embodiments, the guidance instructions refer to natural language instructions and/or other data modalities (e.g., image or video) in addition to a selected system prompt. In particular, the guidance instructions refer to additional context or instructions for the selected system prompt. In one or more embodiments, the autonomous software agent system 100 modifies a selected system prompt from the playbook library 216 according to guidance instructions received from a user computing device. To illustrate, the autonomous software agent system 100 replaces generalizable elements within a selected system prompt with data from the guidance instructions.

In one or more embodiments, a system prompt includes one or more parameterized placeholders that are syntactically delimited using structured tokens. Each placeholder is associated with a parameter definition comprising a parameter name, a data type, a required or optional designation, a default value, and validation constraints. In some embodiments, the autonomous software agent system 100 is configured to resolve placeholder variables at execution time by substituting user-provided inputs, guidance instructions, attached file metadata, or environment-derived values.

In some embodiments, prior to deploying an autonomous software agent, the autonomous software agent system 100 performs parameter validation to ensure that required parameters are populated and that type constraints are satisfied. If validation fails, the system prompts the user computing device for corrective input before initiating the development session. In this manner, the autonomous software agent system 100 enforces deterministic instantiation of reusable playbooks across varying execution contexts.

FIG. 3 illustrates an overview of the autonomous software agent system 100 generating artificial intelligence outputs by deploying an autonomous software agent in accordance with one or more embodiments. For example, FIG. 3 shows the autonomous software agent system 100 accessing/receiving a prompt 302 (e.g., a system prompt selected from a playbook library and/or guidance instructions from a user computing device). In particular, the prompt 302 refers to a system prompt, a natural language prompt 302a (from a user computing device), an application programming interface call 302b, and/or a tag/mention 302c in a messaging application.

In some embodiments, via an API, a user computing device can build custom workflows using an API of the autonomous software agent system 100 and programmatically assign tasks for the autonomous software agent system 100 to perform. Further, with the API, users of computing devices can essentially plug in the autonomous software agent system 100 to any of their software development and internal tools.

In one or more embodiments, the autonomous software agent system 100 exposes a programmatic interface for invoking specific playbooks via an application programming interface. A playbook execution request includes a playbook identifier, parameter values, execution context metadata, and authorization credentials. The autonomous software agent system 100 validate the request, retrieve the specified playbook version, perform parameter binding, and initialize a development session accordingly. In one or more embodiments, playbook execution may be triggered via webhook events, continuous integration pipelines, or scheduled automation triggers.

In some embodiments, the autonomous software agent system 100 deploys an autonomous software agent in response to being triggered by a code editor. In particular, from another code editor/integrated development environment (IDE), users of computing devices who use visual studio code (or visual studio code forks) can assign tasks to the autonomous software agent system 100 directly from their code editor/IDE.

As mentioned, in some embodiments, the autonomous software agent system 100 can deploy an autonomous software agent in response to being tagged/mentioned in a third-party messaging application. In particular, user computing devices can tag the autonomous software agent system 100 directly from conversations they are having with colleagues in the messaging application. Furthermore, the autonomous software agent system 100 will reply directly in the messaging thread and anyone can jump into the thread and provide further instructions to the autonomous software agent system 100.

In some embodiments, the autonomous software agent system 100 integrated with a third-party messaging application further includes a centralized server. In particular, the autonomous software agent system 100 utilizes a centralized server that is responsible for forwarding information between the autonomous software agent system 100 and the third-party messaging application. To illustrate, a user of a computing device can install a messaging integration for the autonomous software agent system 100 into a messaging workspace and further add the integration to the relevant channels of a messaging application.

In some embodiments, if the autonomous software agent system 100 receives a tag/mention of an autonomous software agent in the third-party messaging application, then the autonomous software agent system 100 utilizes a centralized server to recognize the tag/mention. Furthermore, the autonomous software agent system 100 passes that tag/mention along to a web server backend that a website hosted by the autonomous software agent system 100 uses to start a new session (e.g., initiate an autonomous software agent for deployment).

As further shown in FIG. 3 and as discussed above, the autonomous software agent system 100 further accesses/receives knowledge 304. In particular, the knowledge 304 can include a development environment, guidelines, code repositories, and/or one or more software tasks. In some embodiments, the knowledge 304 refers to a form of “memory” (e.g., memory inputs) that allows the autonomous software agent system 100 to retrieve information based on specific triggers that might be relevant to a session of the autonomous software agent.

As further shown in FIG. 3, the autonomous software agent system 100 further performs an act 306 of deploying an autonomous software agent (e.g., a cloned virtual machine that is isolated and can perform tasks siloed from other devices). Moreover, as shown in FIG. 3, the autonomous software agent system 100 further provides to the autonomous software agent a shell tool 308, a browser tool 310, an integrated development environment 312 (e.g., an editor), and a planner tool 314.

For example, a shell tool 308 refers to an interface layer that mediates interaction between an artificial intelligence (AI) agent and an underlying execution environment, computing system, development environment, or virtualized runtime. The shell tool 308 provides a structured command, control, and input/output framework through which the autonomous software agent system 100 issues instructions, receives responses, and orchestrates software development operations. A shell tool 308 may comprise a command-line interpreter, application programming interface (API) interface, remote procedure call (RPC) interface, messaging interface, terminal emulator, container interface, virtual machine interface, or any combination thereof. The shell tool 308 abstracts underlying system resources-including file systems, process control, compilers, interpreters, debuggers, network interfaces, and package managers- and presents a controllable operational surface to the autonomous software agent system 100.

As used herein, a browser tool 310 (or simply browser) refers to a software component executing within an independent virtual machine computing environment and configured to retrieve, render, interpret, and interact with network-accessible resources on behalf of an autonomous software agent system 100. A browser tool 310 operates as a controlled network interaction interface within the independent virtual machine computing environment and provides the autonomous software agent system 100 with programmatic access to web content, application interfaces, documentation repositories, APIs, development resources, and other remote computing services. A browser tool 310 may implement one or more communication protocols, including HTTP, HTTPS, WebSocket, or other network transport protocols.

In the context of the autonomous software agent system 100, a browser tool 310 may be configured to retrieve web pages, API responses, source code repositories, software documentation, or structured data from remote systems; render and parse markup languages including HTML, XML, Markdown, and script-generated content; execute client-side scripts in a sandboxed runtime; extract structured representations of document object models (DOMs), metadata, form fields, and interactive elements; submit forms, authenticate sessions, manage cookies or tokens, and maintain session state; download, upload, or modify remote resources under controlled permissions; provide machine-readable representations of rendered content to the autonomous software agent system 100 for reasoning and code generation; and enforce network policies, domain restrictions, rate limits, and security guardrails.

In some embodiments, a browser tool 310 is configured to expose structured outputs such as DOM trees, accessibility trees, rendered text, event traces, console logs, or network traces-rather than or in addition to graphical output. A browser tool 310 may operate in headless mode and may be programmatically controlled via an automation interface.

A browser tool 310, as part of the independent virtual machine computing environment, is isolated from a host computing system and subject to resource constraints, execution monitoring, and security policies defined by the independent virtual machine computing environment. This isolation permits the autonomous software agent system 100 to perform research, dependency resolution, API inspection, automated testing of web applications, or code retrieval without exposing the host environment to uncontrolled network interactions. Unless expressly limited, a browser tool 310 encompasses any web client, headless browsing engine, embedded rendering engine, automated browsing framework, or network-interaction module configured to retrieve and interact with remote content within a virtualized execution environment controlled by the autonomous software agent system 100.

In some embodiments, the integrated development environment (IDE) 312 refers to an editor tool to write computer code and computer tests. In some embodiments, the integrated development environment 312 is a software application that brings together software tools for software development. In particular, the integrated development environment 312 refers to a software application that combines essential software development features (e.g., coding, debugging, testing, and deployment) to increase the efficiency of completing software projects. The IDE 312 may further maintain structured representations of a project state, including file hierarchies, dependency graphs, abstract syntax trees (ASTs), symbol tables, error diagnostics, execution traces, and build artifacts. In the context of the autonomous software agent system 100, the IDE 312 is configured to one or more software tasks; create, edit, refactor, or delete source files; invoke compilation or interpretation processes; execute unit tests or integration tests; surface compiler diagnostics and runtime errors; perform automated refactoring or formatting; manage branches and commits within a version control system; and return structured, machine-readable feedback to the autonomous software agent system 100 to enable iterative reasoning and code refinement.

In some embodiments, the integrated development environment 312 is a fully featured application that allows an autonomous software agent to write, test, and debug code without switching between different software applications. For example, the integrated development environment can include a code editor (e.g., syntax highlighting, code completion, etc.), a compiler/interpreter (e.g., converts source code into executable program code), a debugger (e.g., to find and fix computer code errors), a file browser (e.g., to navigate through files in a centralized development platform), version control (e.g., commit, push, pull, merge computer code in a code repository), and a terminal (e.g., direct command execution to run scripts or access computer system utilities).

In some embodiments, the autonomous software agent system 100 provides a code editor to the autonomous software agent, where the code editor is a sub-component of the integrated development environment. In other words, in some embodiments, the autonomous software agent system 100 provides a fully featured IDE that merges the functionalities of a code editor and the shell tool 308.

Accordingly, the autonomous software agent system 100 provides the autonomous software agent with its own IDE (e.g., independent of a computer code development environment of a user computing device that submitted the prompt 302) to perform software coding tasks. In other words, the autonomous software agent has full access to the integrated development environment 312, which enables the autonomous software agent to complete complex software development tasks.

In one or more embodiments, the planner tool 314 refers to an artificial intelligence model that analyzes a prompt 302 and plans how to execute one or more corresponding software tasks. In particular, the planner tool 314 breaks down a software task to manageable tasks and generates an artificial intelligence plan. In some embodiments, the autonomous software agent system 100 utilizes the planner tool 314 to generate the artificial intelligence plan and presents the artificial intelligence plan to a user computing device to modify or confirm one or more aspects in the artificial intelligence plan.

More specifically, that planner tool is configured to analyze one or more input objectives, user intents, or software task specifications and to generate structured, multi-step plans that guide operation of an autonomous software agent system 100 in performing code generation, modification, testing, analysis, or orchestration tasks. The planner tool 314 may be implemented using one or more underlying computational models, including but not limited to large language models (LLMs), transformer-based neural networks, sequence-to-sequence models, reinforcement learning models, probabilistic graphical models, symbolic reasoning engines, constraint solvers, heuristic search algorithms, or hybrid neuro-symbolic architectures. In one or more embodiments, planner tool 314 leverages a generative pretrained transformer model, including a code-capable language model, to infer task structure, identify implicit constraints, and predict ordered action sequences based on prior training across natural language corpora, source code repositories, execution traces, and software development workflows.

In one or more embodiments, the planner tool 314 is configured to decompose complex objectives into a sequence of actionable subtasks, determine dependencies and ordering among subtasks, and construct an execution plan consumable by downstream components such as code generation modules, debugging modules, the browser tool 310, the shell tool 308, IDE 312, testing frameworks, or other tool interfaces. The generated plan may comprise, without limitation, a hierarchical task tree, directed acyclic graph (DAG), ordered action list, state machine representation, or other structured plan representation including defined inputs, outputs, preconditions, postconditions, and success criteria.

In certain embodiments, planner tool 314 employs prompt-based reasoning, chain-of-thought inference, tree search, beam search, Monte Carlo sampling, reinforcement learning-based policy selection, or combinations thereof to evaluate multiple candidate plans and select or refine a plan according to defined optimization metrics. The planner tool 314 may further incorporate memory mechanisms, including contextual embeddings, vector databases, episodic execution logs, or persistent state representations, to inform plan generation based on prior interactions or historical outcomes. The planner tool 314 may monitor intermediate execution results and dynamically revise, re-order, expand, or prune subtasks based on feedback including compiler diagnostics, runtime errors, test failures, environmental changes, or external tool responses. In this manner, planner tool 314 supports iterative, adaptive, reactive, or predictive planning strategies. In some embodiments, the planner tool 314 operates as a distinct module that communicates with other components of autonomous software agent system 100 via structured messages, application programming interfaces (APIs), or message-passing protocols.

In one or more embodiments, the autonomous software agent system 100 utilizes the planner tool 314 to generate an artificial intelligence plan in accordance with one or more embodiments. In particular, the autonomous software agent system 100 accesses/receives the prompt 302 (e.g., from a user computing device). Furthermore, the autonomous software agent system 100 deploys an autonomous software agent to operate within an independent virtual machine computing environment.

As mentioned, the autonomous software agent system 100 utilizes the planner tool 314 to improve the efficiency and accuracy of executing a software task from the prompt 302. In some embodiments, the autonomous software agent system 100 utilizes the planner tool 314 to generate a running “to do” list. In particular, the autonomous software agent system 100 can use the planner tool 314 to break down the prompt 302 and to infer one or more intents of the prompt 302. In one or more embodiments, the autonomous software agent system 100 utilizes the planner tool 314 to assist a user in visualizing how the autonomous software agent (e.g., deployed by the autonomous software agent system 100) plans and thinks through solving a problem (e.g., as indicated in the prompt 302).

In some embodiments, the autonomous software agent system 100 utilizes a large language model (e.g., a planning model) to analyze the prompt. In one or more embodiments, the autonomous software agent system 100 utilizes the large language model that leverages retrieval-augmented generation (RAG) to generate an artificial intelligence plan. In some embodiments, retrieval-augmented generation refers to retrieving relevant information from an external database or knowledge source in the context of the prompt 302. In particular, the autonomous software agent system 100 can utilize RAG (e.g., which includes using the large language model) to generate a response (e.g., the artificial intelligence plan) by leveraging both the retrieved information (from an external source) and its own internal knowledge base. In particular, the autonomous software agent system 100 leverages RAG, which includes an input query, information retrieval, and response generation to perform a task of generating the artificial intelligence plan.

In some embodiments, the autonomous software agent system 100 further utilizes the large language model to perform an act of extracting a meta-task from the prompt 302. Moreover, as shown, the autonomous software agent system 100 performs an act of extracting intermediate tasks (e.g., sub-tasks) from the meta-task. In one or more embodiments, the autonomous software agent system 100 analyzes the prompt 302, determines an intent (e.g., a meta-task) of the prompt 302, and determines discrete sub-tasks (e.g., intermediate tasks).

In particular, the autonomous software agent system 100 can prompt the large language model to divide the prompt 302 into manageable and discrete sub-portions. In other words, the autonomous software agent system 100 prompts the large language model to identify tasks that point to different code repositories, data sources, and systems as being their own sub-task. In particular, the autonomous software agent system 100 can prompt the large language model and include example breakdowns of example requests.

Moreover, in some embodiments, the autonomous software agent system 100 trains the large language model with example datasets for breaking down a request into a meta-task and a plurality of sub-tasks. In particular, the autonomous software agent system 100 trains the large language model by having it generate a predicted artificial intelligence plan and comparing the prediction to a ground truth reference.

In some embodiments, the autonomous software agent system 100 utilizes the large language model to generate an artificial intelligence plan to execute a software task. In particular, the autonomous software agent system 100 generates the artificial intelligence plan which includes a meta-task extracted from the prompt 302 and intermediate tasks extracted from the meta-task. In one or more embodiments, the autonomous software agent system 100 provides the artificial intelligence plan to a graphical user interface of a computing device. In particular, the autonomous software agent system 100 provides the artificial intelligence plan to receive approval or modification from a user computing device.

In some embodiments, the autonomous software agent system 100 can receive modifications to one or more tasks/sub-tasks and/or the meta-task extracted from the prompt 302. In some instances, the autonomous software agent system 100 can receive additional context or additional files (e.g., via the third-party messaging application as discussed above) to further customize the artificial intelligence plan. In some embodiments, the autonomous software agent system 100 receives one or more modifications to the artificial intelligence plan and generates a modified artificial intelligence plan.

In some embodiments, the autonomous software agent system 100 receives a selection of a system prompt in addition to guidance instructions from a user computing device. In such cases, the autonomous software agent system 100 utilizes the planner tool 314 to decompose both the system prompt and the guidance instructions. Moreover, the autonomous software agent system 100 can utilize the decomposed guidance instructions to modify one or more aspects of the system prompt. For example, the autonomous software agent system 100 can utilize the planner tool 314 to replace generalizable elements within a system prompt with data from the guidance instructions provided by the user computing device.

As discussed above, in some embodiments, the autonomous software agent system 100 receives a selection of a system prompt from a user computing device. In some embodiments, the autonomous software agent system 100 generates an artificial intelligence system prompt suggestion for a user computing device. In particular, the autonomous software agent system 100 receives the prompt 302 and the autonomous software agent system 100 generates an artificial intelligence plan. In the course of generating the artificial intelligence plan, the autonomous software agent system 100 can identify tasks/sub-tasks of the artificial intelligence plan that have a significant threshold overlap with one or more system prompts within a playbook library.

In one or more embodiments, the autonomous software agent system 100 can identify that tasks/sub-tasks of the artificial intelligence plan have a significant threshold overlap with one or more system prompts by comparing metadata tags of the system prompts in the playbook library with tasks/sub-tasks of the artificial intelligence plan. Moreover, in some embodiments, the autonomous software agent system 100 can generate embedding representations of system prompts in the playbook library and embedding representations of each of the tasks/sub-tasks and compare them within a common embedding space. In doing so, the autonomous software agent system 100 can identify system prompts from the playbook library within a threshold distance (e.g., a significant threshold overlap) of one or more of the tasks/sub-tasks.

Additionally, in some embodiments, the autonomous software agent system 100 can generate the artificial intelligence system prompt suggestions and surface them via a graphical user interface of a user computing device. In particular, the autonomous software agent system 100 can provide each of the generated artificial intelligence system prompt suggestions to the user computing device to approve or reject. For example, in response to a user computing device selecting an artificial intelligence system prompt suggestion, the autonomous software agent system 100 can add the prompt 302 to the selected artificial intelligence system prompt suggestion and generate an updated artificial intelligence plan.

Further, the autonomous software agent system 100 can prompt a user of a computing device to provide approval (e.g., confirmation) of the modified artificial intelligence plan. In response to receiving approval of an (updated) artificial intelligence plan, the autonomous software agent system 100 deploys the autonomous software agent to execute the prompt 302 according to the artificial intelligence plan.

In some embodiments, the autonomous software agent system 100 utilizes the browser tool 310 to perform one or more actions responsive to prompt 302 to execute a software task. For example, the autonomous software agent system 100 accesses/receives the prompt 302. In one or more embodiments, the autonomous software agent system 100 utilizes the browser tool 310 to browse documentation on one or more website domain pages, test web applications (e.g., local applications), download information, upload information, etc. In particular, the autonomous software agent system 100 utilizes the browser tool 310 to perform a first navigation step, a second navigation step, and a third navigation step on a website domain page.

In one or more embodiments, a website page (e.g., a website domain page) refers to a webpage hosted under a domain name that serves as an entry point of a website and is identified by a URL. For example, a website page refers to a digital webpage associated with a domain name that has a unique URL and contains structured content (e.g., text, images, links, and other media). In particular, a website page is part of a larger website hierarchy. To illustrate, a website hierarchy includes a homepage, subpages, and subdomain pages. In some embodiments, a plurality of website pages is associated with an entity.

In one or more embodiments, the autonomous software agent system 100 utilizes the browser tool 310 to obtain information from a website page. In some embodiments, the autonomous software agent system 100 determines whether a particular portion of a website page is relevant to the prompt 302 to execute a software task. In particular, the autonomous software agent system 100 utilizes a large language model (e.g., a website relevance model) to determine the relevance of a sub-portion, portion, or entire website page.

In other words, website domain pages contain an excessive amount of information. In particular, large language models are typically bogged down with processing all elements within a website page. Thus, the autonomous software agent system 100 distills a website page structure (e.g., utilizing the large language model) and provides a simplified structure (e.g., HTML) to the autonomous software agent for further processing. In doing so, the autonomous software agent system 100 enables the autonomous software agent to process a large amount of data from website pages without performance degradation.

In some embodiments, the autonomous software agent system 100 utilizes the large language model to perform an act of determining a document object model (DOM) of a website page. In particular, the autonomous software agent system 100 passes a website page to the large language model to determine a document object model of the website page.

In one or more embodiments, a document object model refers to a structured, hierarchical representation of a webpage's content that defines how HTML elements are programmatically accessed, modified, and analyzed. In one or more embodiments, the autonomous software agent system 100 detects a document object model object within a website page. For example, the DOM includes a representation of structure, content and properties within a website page. For instance, a user of a website page interacts with and manipulates a DOM object. Further, in some embodiments the DOM includes HTML or XML format. Accordingly, the DOM includes references to specific elements or nodes within the website page. To illustrate, DOM objects are part of a DOM tree structure, where each node of the DOM tree structure corresponds to a specific element in a website page.

In some embodiments, the autonomous software agent system 100 utilizes the large language model to perform an act of identifying relevant document object model elements (e.g., DOM elements). In particular, the autonomous software agent system 100 prompts the large language model to identify relevant DOM elements in context of the prompt 302. In other words, the autonomous software agent system 100 utilizes the large language model to distill a website page into a relevant set of elements for the prompt 302.

In some embodiments, the autonomous software agent system 100 utilizes the large language model to generate a simplified DOM tree (e.g., a simplified document object model tree). As mentioned above, in some instances, a website page contains a large amount of data that can potentially bog down computational processes. As such, the autonomous software agent system 100 utilizes the large language model to extract the most salient/relevant elements from a website page (e.g., being browsed via the browser tool 310) and generates the simplified DOM tree.

In one or more embodiments, the simplified DOM tree refers to distilled document object model structure and/or a distilled hierarchical representation of a webpage's content. In particular, the simplified DOM tree includes a hierarchy of nodes and elements from the website page that are relevant to the prompt 302. In other words, the simplified DOM tree contains fewer website page elements relative to an initially determined DOM tree from the website page.

In some embodiments, the autonomous software agent system 100 utilizes the shell tool 308 to generate one or more terminal commands. In one or more embodiments, the shell tool 308 refers to one or more terminals (e.g., one or more terminal windows). In particular, the autonomous software agent system 100 deploys the autonomous software agent that can create new terminal windows or switch to different terminal windows, or delete terminals (e.g., which is how an autonomous software agent can run multiple processes at once). For relatively long commands, the autonomous software agent system 100 can use the autonomous software agent to shift its attention away from the long-running command and multitask in parallel (e.g., via the shell tool 308).

In some embodiments, the shell tool 308 is a text-based application where the autonomous software agent can input commands that interact directly with a computer's operating system. In particular, the autonomous software agent system 100 spins up the autonomous software agent that includes a shell application and in the shell application there are different terminals. As mentioned, where each terminal is like a single terminal window, the autonomous software agent system 100 (e.g., via the autonomous software agent) has the ability to create new terminals, switch to different terminal windows or delete terminals. Furthermore, the autonomous software agent system 100 performs an act of utilizing the autonomous software agent to generate terminal commands. Moreover, the autonomous software agent system 100 generates command outputs.

Accordingly, the autonomous software agent system 100 utilizes the autonomous software agent to execute a software task (e.g., indicated by the prompt 302) by using the shell tool 308. In particular, the autonomous software agent system 100 determines a plurality of sub-tasks for a meta-task indicated in the prompt 302, generates an artificial intelligence plan, and utilizes the shell tool to execute one or more of the sub-tasks (e.g., by submitting terminal commands).

In some embodiments, the autonomous software agent system 100 receives a selection of a shell feature and opens/launches an interactive shell of the autonomous software agent. In particular, the autonomous software agent system 100 causes a graphical user interface (e.g., of a user computing device) to show shell activity (e.g., terminal commands or outputs corresponding to terminal commands) of the autonomous software agent utilizing the shell tool 308 while independently performing the software task. Accordingly, the user computing device (e.g., via the graphical user interface) can intervene (e.g., take over) the autonomous software agent's shell and push a software task in a different direction.

Moreover, the autonomous software agent system 100 provides the integrated development environment 312 (IDE tool) to the autonomous software agent. In one or more embodiments, the integrated development environment 312 of the autonomous software agent includes an editor (e.g., in some embodiments, the autonomous software agent utilizes multiple editor tabs which represent open files in an editor area of the IDE for writing/editing computer code). In particular, the editor corresponds to an open file.

As mentioned above, the autonomous software agent has access to its own editor. In some embodiments, an editor refers to a software program or tool for writing or modifying computer code. In particular, an editor streamlines a computer code writing process by providing syntax highlighting, auto-completion, and error detection. For example, the editor provides color-coding for keywords, variables, functions, and other code elements. Further, for auto-completion, the editor suggests completions for variables, methods, classes, and functions.

In some embodiments, project files refer to a set of files and resources organized together to represent a specific software coding task (e.g., project). For example, the project files can include source code (e.g., program code written in a specific programming language), configurations (e.g., settings defining how a project is built, compiled, and executed), dependencies (e.g., external libraries), libraries, assets, and other components required to complete a software coding task. In some embodiments, the autonomous software agent system 100 utilizes the integrated development environment 312 to perform an act of generating computer code.

As noted above, in one or more embodiments, the autonomous software agent system 100 provides actions performed by the autonomous software agent to a graphical user interface of a user (e.g., a user computing device). In particular, in the context of the integrated development environment 312, the autonomous software agent system 100 can provide to a graphical user interface real-time actions and/or actions performed during a development session of the autonomous software agent utilizing the integrated development environment 312. As discussed above, in some embodiments, the autonomous software agent system 100 provides actions performed by the autonomous software agent to a third-party messaging application.

In some embodiments, the autonomous software agent system 100 can receive an input selection that relates to a user computing device indicating a desire to modify one or more inputs in the integrated development environment 312. Further, in some embodiments, the autonomous software agent system 100 can receive an input selection to follow the autonomous software agent (e.g., in real-time) as the autonomous software agent executes a software task indicated by the prompt 302.

In some embodiments, the autonomous software agent system 100 provides for display the integrated development environment 312 that includes the above-mentioned editor tab. Further, in some instances, the autonomous software agent system 100 also provides a problems tab which lists errors, warnings, and information for computer code (in the editor tab) for a user to efficiently see errors in computer code or jump to problematic portions of computer code), an output tab (e.g., shows logs and messages from the IDE or extensions of the IDE to be notified of background activities like loading data onto a server or plugin operations), a debug console (e.g., allows for interactions with a program during debugging, such as viewing runtime logs, evaluating expressions, or inspecting variables), a terminal (e.g., a built-in shell/command-line interface for executing/submitting commands to a terminal, such as running scripts or installing packages), and a version control tab (e.g., provides information as to which devices submitted changes to a code repository and why the changes were submitted to a code repository).

In one or more embodiments, the autonomous software agent system 100 receives one or more inputs to modify computer code in the integrated development environment 312 from a third-party messaging application. In particular, the autonomous software agent system 100 provides outputs (e.g., computer code) from the autonomous software agent utilizing the integrated development environment 312.

More specifically, in one or more embodiments, the autonomous software agent system 100 is configured to automatically (e.g., without further user instructions other than the prompt defining the software task) perform an assigned software task using coordinated interaction among planner tool 314, browser tool 310, an integrated development environment (IDE) 312, a shell tool 308, and an independent virtual machine computing environment. For example, upon receiving a software task-expressed in natural language, structured specification, source code fragment, test case, or other machine-interpretable format—the autonomous software agent system 100 provides the software task to planner tool 314. The planner tool 314 analyzes the objective and generates a structured execution plan comprising an ordered set of subtasks, dependency relationships, required tools, expected outputs, and validation criteria. The execution plan may define actions such as retrieving documentation, generating source code, creating files, compiling code, executing tests, debugging failures, refactoring modules, or deploying artifacts. The autonomous software agent system 100 executes the structured plan within the independent virtual machine computing environment. Where plan steps require external information or dependency retrieval, the autonomous software agent system 100 invokes the browser tool 310 within the independent virtual machine computing environment. The autonomous software agent system 100 uses the browser tool 310 to retrieve and parse remote documentation, API specifications, repositories, or other network-accessible resources and returns structured, machine-readable representations to autonomous software agent system 100 for reasoning and code synthesis.

For code authoring and modification operations, the autonomous software agent system 100 interacts with the IDE 312. The IDE 312 enables creation, editing, refactoring, and organization of source files, as well as invocation of compilers, interpreters, build systems, static analysis tools, and test frameworks. The IDE 312 provides structured diagnostics, including syntax errors, semantic warnings, dependency conflicts, and build logs, which are returned to autonomous software agent system 100. Where system-level commands are required, autonomous software agent system 100 issues instructions through the shell tool 308 executing within the independent virtual machine computing environment. The shell tool 308 enables file system manipulation, dependency installation, build execution, test invocation, process control, and other operating system-level operations. Structured outputs including exit codes, logs, and error streams are returned to autonomous software agent system 100.

The planner tool 314, in one or more implementations, monitors intermediate results generated by the IDE 312, browser tool 310, and shell tool 308, and compares those results against plan-defined success criteria. If discrepancies, failures, or unexpected states are detected, the planner tool 314 automatically revises the execution plan, generates corrective subtasks, reorders actions, or initiates debugging procedures. This iterative loop continues until the software task satisfies defined completion conditions or termination criteria. In this manner, autonomous software agent system 100 autonomously decomposes, executes, validates, and refines development actions within the independent virtual machine computing environment using coordinated tool invocation and structured feedback processing. The integration of planner tool 314, browser tool 310, the 312, the shell tool 308, and the independent virtual machine computing environment enables end-to-end automated software development, testing, and validation without direct human intervention.

Accordingly, FIG. 3 shows the autonomous software agent system 100 generating artificial intelligence output(s) 316. In particular, FIG. 3 shows the autonomous software agent system 100 utilizing the autonomous software agent to access/switch between the shell tool 308, the browser tool 310, the integrated development environment 312, and/or the planner tool 314 to generate the artificial intelligence output(s) 316 that are responsive to the prompt 302 (e.g., a selected system prompt from a playbook library).

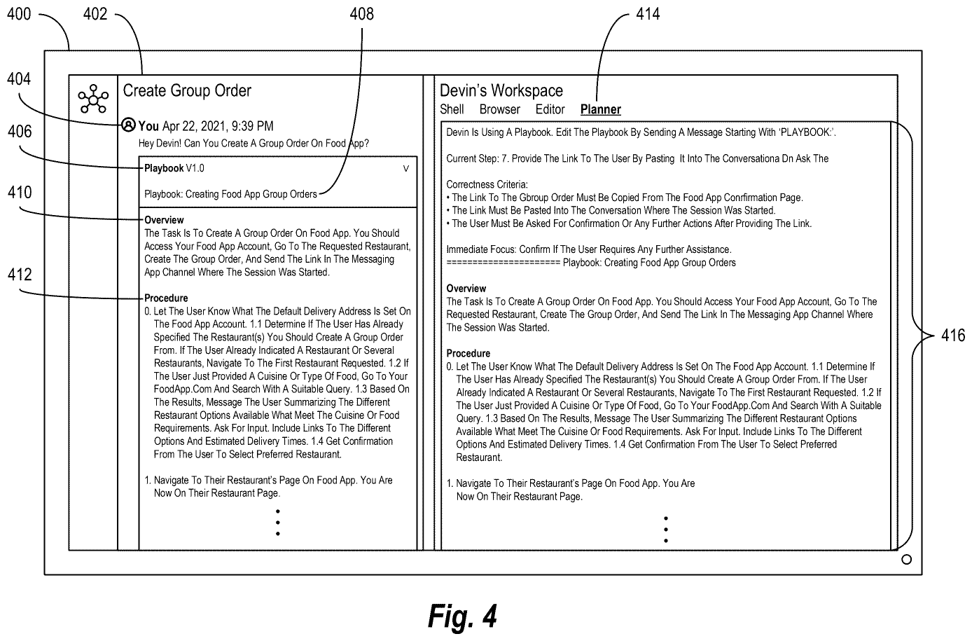

FIG. 4 illustrates an example graphical user interface 402 presented on a user computing device 400 during execution of a playbook by the autonomous software agent system 100. The graphical user interface 402 includes a first pane configured to display a user-agent conversation session. Specifically, FIG. 4 shows a first message 404 that contains guidance instructions and a selected system prompt 406. For instance, FIG. 4 shows that the selected system prompt 406 includes a title 408.

In one or more embodiments, the first pane of the graphical user interface 402 displays user-generated messages and system-generated responses transmitted between the user computing device and backend services. The autonomous software agent system 100 transmits user input received through the first pane to transmitted to the backend services, which determine whether to initiate ad hoc task planning or bind the session to a selected playbook stored within the playbook library 102. Upon activation of a playbook, the autonomous software agent system 100 associate the session with a playbook identifier and version identifier and initialize a playbook execution state object stored in session metadata.

The graphical user interface 402 includes a second pane 416 configured to display a workspace view associated with an independent virtual machine computing environment provisioned for the session. FIG. 4 shows that the selected system prompt 406 includes a procedure 412 listing the procedure that the agent will following when executing the playbook. Moreover, FIG. 4 shows a planner interface 414 and an artificial intelligence plan generated based on the selected playbook in the second pane 416. In one or more embodiments, the second pane 416 displays a workspace corresponding to the independent virtual machine computing environment in which the autonomous software agent operates. The workspace includes multiple selectable tool tabs, including without limitation a shell tool interface, a browser tool interface, an integrated development environment editor, and a planner interface. Selection of the planner interface causes rendering of structured playbook content, including procedural steps, correctness criteria, and dynamic execution state information.

In one or more embodiments, the planner interface displays a current step indicator that reflects a step index maintained within a playbook execution state. The playbook execution state stores, for each procedural step, a step identifier, execution status, and completion metadata. Upon successful satisfaction of step-specific post conditions or validation criteria, the autonomous software agent system 100 transitions the current step pointer to a subsequent step and updates the graphical user interface 402 via a real-time state update channel. In some embodiments, state updates are transmitted using a streaming protocol to synchronize backend execution progress with the client-side graphical interface.

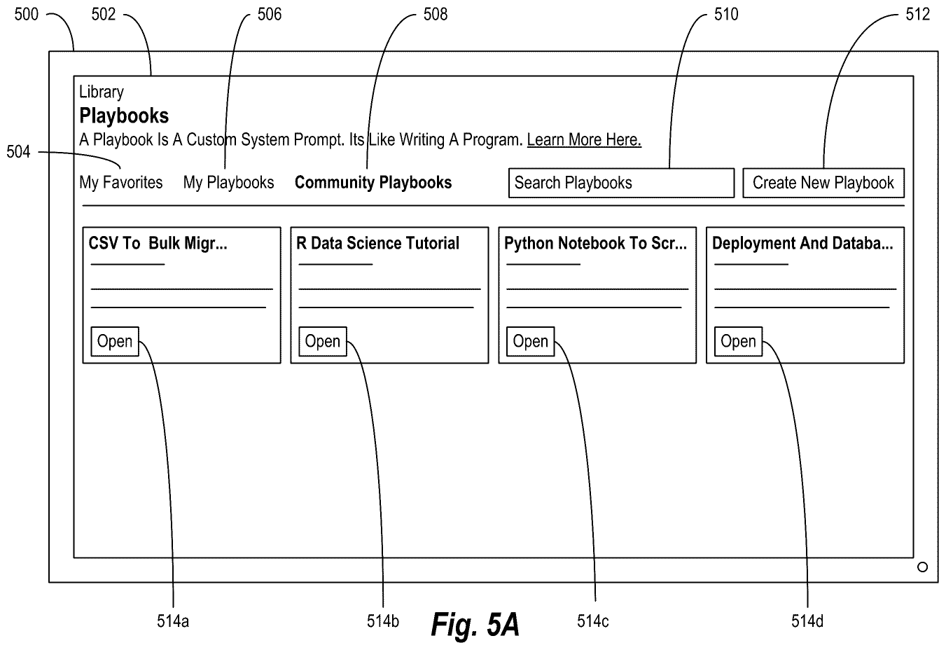

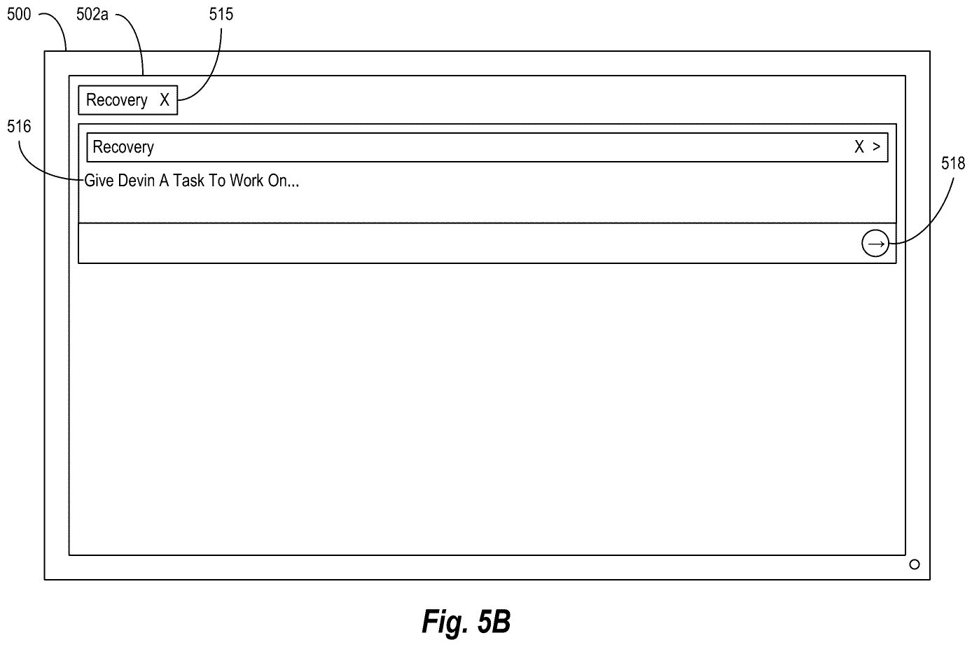

FIG. 5A shows a general interface for presenting available playbooks (e.g., previously created by a user or already created by the autonomous software agent system 100). More specifically, FIG. 5A illustrates an example graphical user interface 502 for interacting with a playbook library 102. The graphical user interface 502 is rendered on a user computing device 500 and communicates with backend services that store, index, version, and manage structured playbooks.

In one or more embodiments, the graphical user interface 502 includes category selectors 504 that segment stored playbooks according to access scope and ownership attributes. In particular, FIG. 5A shows a favorite element 504 (e.g., to view favorite system prompts of a user computing device), a personalized playbook element 506 (e.g., to view personally created system prompts), and a community playbook element 508 (e.g., to view community created system prompts). In one or more implementations, a category selection triggers a filtered query to backend services, which retrieve playbooks based on metadata fields including author identifier, tenant identifier, permission attributes, lifecycle state, and sharing scope.

In one or more embodiments, the graphical user interface 502 includes a search field 510 configured to receive search input and transmit the input to backend services for execution of a structured query. The backend services perform a search operation across playbook metadata and content fields. In some embodiments, the search operation includes keyword indexing, tag matching, and semantic similarity comparison using embedding vectors stored for each playbook. Search results are ranked based on relevance scores derived from similarity thresholds, usage frequency, success rate metrics, or user feedback signals.

In one or more embodiments, each playbook is represented as a playbook card 514a-514d rendered within the graphical user interface 502. Each playbook card corresponds to a structured playbook data object stored within the playbook library 102 and includes summary metadata such as playbook title, brief description, and optionally version identifier or author information. The “Open” control associated with each card transmits a playbook selection request to backend services. In response, backend services retrieve a specified playbook version, perform parameter validation if required, and initialize a playbook execution state object for binding to a new or existing development session.

In one or more embodiments, the “Create New Playbook” control 512 triggers generation of a new structured playbook object within the playbook library 102. Backend services allocate a unique playbook identifier, initialize default metadata fields, and optionally prepopulate required sections according to a predefined playbook schema. In some embodiments, creation of a new playbook invokes validation routines that enforce required structural components, including procedure sections, specification sections, and constraint definitions.

In one or more embodiments, the autonomous software agent system 100 enforces role-based access control (RBAC). For example, each playbook is associated with permission attributes defining view, execute, modify, share, and delete privileges. The autonomous software agent system 100 verifies authorization tokens corresponding to a user account prior to permitting execution or modification of a playbook. In multi-tenant deployments, tenant identifiers are embedded within playbook metadata to enforce cross-tenant isolation.

FIG. 5B shows a graphical user interface 502a for aid in creating a new playbook 515 (e.g., entitled recovery) that opens upon the selection of the “Create New Playbook” control 512. The graphical user interface 502a is rendered on a user computing device 500 and communicates with backend services that validate, structure, version, and store playbook definitions as executable data objects.

In one or more embodiments, the graphical user interface 502a includes an authoring pane 516 configured to receive structured playbook content. The structured playbook content may include one or more predefined sections, including without limitation: a procedure section comprising ordered execution steps; a specifications section defining required outputs or post conditions; a parameter definition section specifying required or optional input variables; a forbidden actions section defining execution constraints; an advice section containing heuristic guidance; and a dependency declaration section identifying runtime requirements.

In one or more embodiments, the autonomous software agent system 100 graphical enforces a predefined schema during playbook creation. Upon receiving playbook content input, the autonomous software agent system 100 parses the content and validates structural compliance with the predefined schema. For example, the autonomous software agent system 100 verifies the presence of required sections, confirming syntactic formatting of ordered steps, ensuring parameter definitions include data types and default values, and confirming that constraint definitions are machine-interpretable. If validation fails, error indicators are transmitted to the user computing device for correction prior to persistence of the playbook.

In one or more embodiments, selection of a save or confirmation control 518 causes the autonomous software agent system 100 to transmit of a structured playbook creation request. For example, the autonomous software agent system 100 generate a unique playbook identifier, initialize a version identifier (e.g., version 1.0), associates metadata including author identifier and tenant identifier, and stores the playbook as a structured data object within the playbook library 102.

In one or more embodiments, the autonomous software agent system 100 utilizes the playbook creation graphical user interface 502a to support dynamic preview or linting functionality. For example, as content is entered into the authoring pane 516, the autonomous software agent system 100 may evaluate procedural steps for ambiguity, detect missing validation criteria, identify potential conflicts between advice sections and forbidden actions, and generate recommended structural improvements. In certain embodiments, the autonomous software agent system 100 transforms natural language content into a structured intermediate representation to enable machine-level execution.

In one or more embodiments, the graphical user interface 502a further allows specification of dependency declarations identifying required programming languages, runtime environments, external service integrations, file system permissions, or tool capabilities as part of a playbook creation. The autonomous software agent system 100 stores any declared dependencies as structured metadata and are used during subsequent playbook execution to select or provision an appropriate independent virtual machine computing environment.

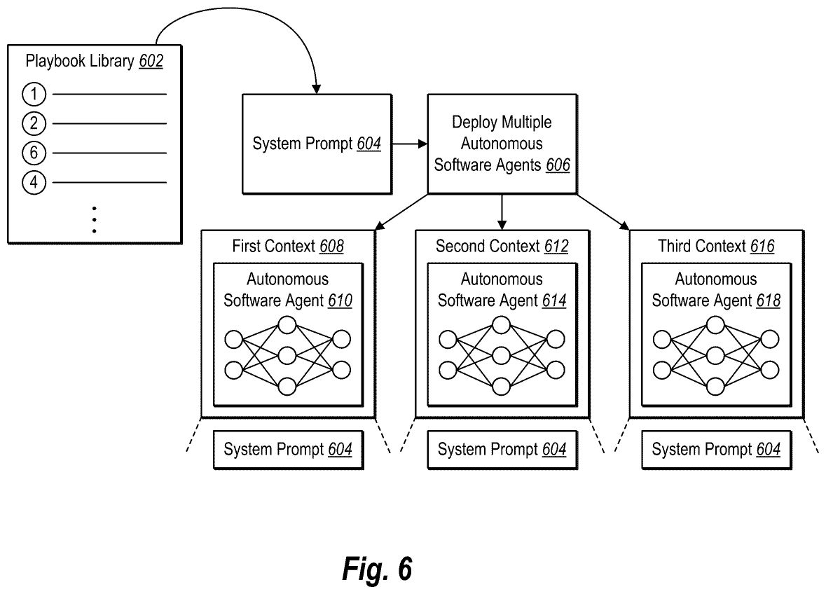

FIG. 6 illustrates the autonomous software agent system 100 utilizing a system prompt to deploy multiple autonomous software agents in accordance with one or more embodiments. For example, FIG. 6 shows the autonomous software agent system 100 receiving a selection of a system prompt 604 from a playbook library 602. Moreover, FIG. 6 shows the autonomous software agent system 100 performing an act 606 of deploying multiple autonomous software agents according to the system prompt 604 (e.g., a playbook 604).

As shown in FIG. 6, the autonomous software agent system 100 deploys an autonomous software agent 610 within a first context 608 to execute the system prompt 604, an autonomous software agent 614 within a second context 612 to execute the system prompt 604, and an autonomous software agent 618 within a third context 616 to execute the system prompt 604.

In one or more embodiments, FIG. 6 illustrates deployment of a reusable system prompt 604 (e.g., playbook) to multiple autonomous software agents 610, 614, and 618 operating in parallel across distinct execution contexts 608, 612, and 616. The reusable system prompt 604 is retrieved from the playbook library 602 and instantiated independently within each context, thereby enabling concurrent execution of substantially similar structured workflows without requiring repeated authoring or manual reconfiguration.

Because the system prompt 604 is stored as a structured, parameterizable artifact, the autonomous software agent system 100 can deploy multiple instances simultaneously. This eliminates redundant planning overhead and reduces computational latency that would otherwise arise from re-generating task decomposition logic independently for each context.

In some embodiments, the planner tool 314 generates a reusable execution graph corresponding to the system prompt 604. The execution graph may be cached and reused across multiple autonomous software agents, thereby reducing repeated large language model inference required to derive procedural structure. By reusing a pre-validated execution graph, the autonomous software agent system 100 conserves compute cycles, decreases token consumption, and shortens initialization time for subsequent agents.

In one or more embodiments, parallel deployment of autonomous software agents across contexts 608, 612, and 616 enables horizontal scaling of task execution. Each autonomous software agent operates within an independent virtual machine computing environment, thereby isolating file systems, dependency configurations, and intermediate artifacts. This isolation permits simultaneous execution without contention for shared resources and reduces blocking operations that would otherwise serialize workflow completion.

In one or more embodiments, the use of a shared playbook (e.g., system prompt 604) further improves execution reliability and reduces error rates. Because the same validated procedural structure is reused across multiple contexts, debugging efforts and validation logic need only be performed once per version of the playbook. Subsequent parallel executions benefit from the validated structure and reduction of failure conditions.

In one or more embodiments, parallel execution enabled by reusable playbooks (e.g., system prompt 604) reduces total wall-clock time required to complete distributed software tasks. Rather than executing tasks sequentially within a single autonomous software agent, the autonomous software agent system 100 distributes task instances across multiple isolated environments. This parallelization architecture increases throughput, improves responsiveness to user requests, and enhances scalability of the autonomous software agent system.

In one or more embodiments, when multiple autonomous software agents execute a common playbook across different contexts, the autonomous software agent system 100 establishes a coordination channel between the independent virtual machine computing environments. The coordination channel may comprise shared state synchronization, distributed locking mechanisms for repository modifications, and event broadcasting to prevent conflicting write operations. In some embodiments, the autonomous software agent system 100 aggregates intermediate outputs from multiple autonomous software agents and synthesizes a consolidated execution report.

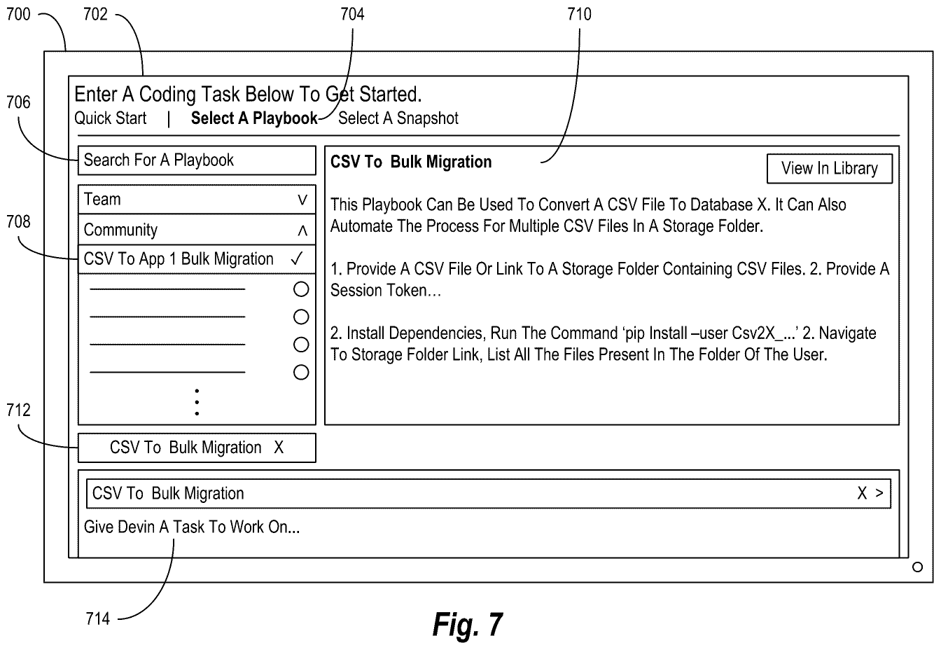

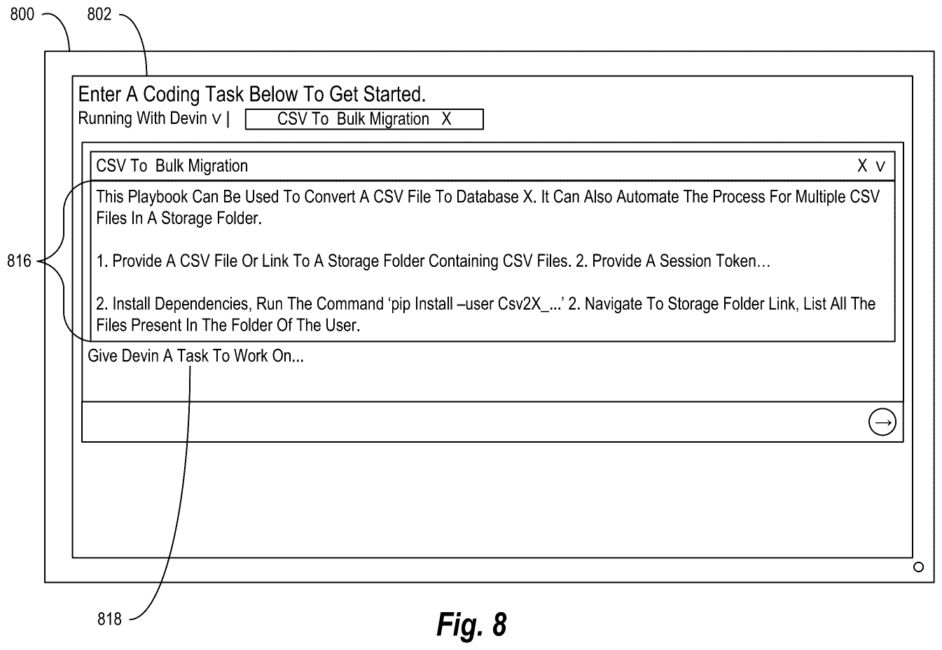

FIGS. 7 and 8 illustrate an example graphical user interface 702 for selecting and activating a playbook within a development session of the autonomous software agent system 100. As shown, the graphical user interface 702 is rendered on a user computing device 700 and communicates with backend services that retrieve, validate, bind, and execute structured playbooks stored within the playbook library 102.

In one or more embodiments, FIG. 7 illustrates a playbook selection interface (e.g., graphical user interface 702) accessible prior to initiation of a development session. The graphical user interface 702 includes a search field 706 configured to receive user input identifying a desired playbook. Upon receiving search input, the autonomous software agent system 100 execute a structured query across playbook metadata and content fields. In some embodiments, the autonomous software agent system 100 using a query comprising one or more of keyword indexing, tag filtering, and semantic similarity comparison using embedding vectors associated with each playbook.

In one or more embodiments, playbooks are segmented by scope (e.g., team, community) by the playbook filter element 708. Specifically, the autonomous software agent system 100 filters visible playbooks based on one or more drop downs or selections. Upon selection of a playbook (e.g., “CSV To Bulk Migration”), the graphical user interface 702 displays a playbook details pane 710 that includes details about the selected system prompt (e.g., playbook). In some embodiments, the autonomous software agent system 100 retrieves the playbook details shown in the playbook details pane 710 from a structured playbook definition including a procedure section, parameter schema, dependency declaration, and validation criteria.

In one or more embodiments, selection of the playbook via control element 712 transmits a playbook activation request to backend services. The autonomous software agent system 100 utilizes the backend services retrieve a specified version of the playbook, validate required parameters, and initialize a playbook execution state object associated with a new or existing development session.

In one or more embodiments, FIG. 8 illustrates the graphical user interface 802 after a playbook has been selected. Specifically, FIG. 8 shows an expanded view 816 of the selected system prompt details. FIG. 8 also illustrates an input element 818 to provide additional context/guidance for the selected system prompt. In one or more embodiments, the autonomous software agent system 100 interprets the user input entered into task input field 818 within the context of the bound playbook. Unlike ad hoc prompting, input provided after playbook activation is processed as parameter instantiation, contextual clarification, or execution guidance consistent with the structured workflow defined by the playbook. In one or more embodiments, activation of a playbook enables deterministic initialization of execution logic. Because the procedural structure has been pre-defined and validated, the autonomous software agent system 100 reduces planning latency and minimizes ambiguity in task decomposition. The playbook binding process therefore improves execution consistency, reduces token consumption during planning, and decreases the likelihood of execution divergence across sessions.

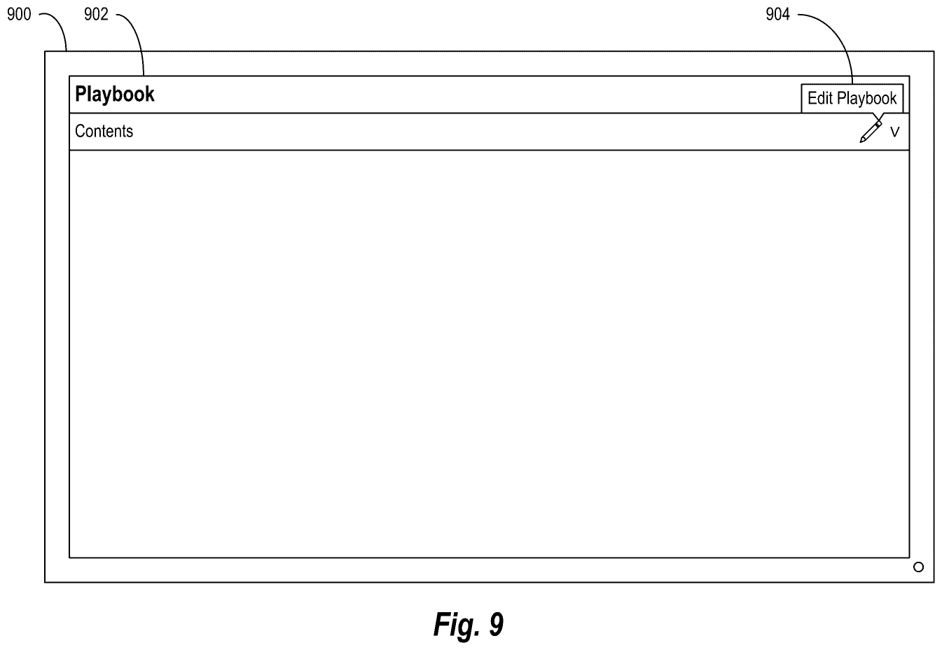

Moreover, FIG. 9 illustrates a graphical user interface 902 of a user computing device 900 displaying an option to modify a playbook. For example, FIG. 9 shows an edit playbook element 904. In response to a selection of the edit playbook element 904, the autonomous software agent system 100 transitions the graphical user interface 902 to show options for re-configuring the selected system prompt (e.g., playbook). In particular, the autonomous software agent system 100 can receive modifications to various sections of a system prompt, such as a procedure section, a specifications section, and the other sections discussed above.

In one or more embodiments, the autonomous software agent system 100 generates a playbook from session logs. For example, the autonomous software agent system 100 analyzes execution logs of prior development sessions to detect recurring task patterns. The autonomous software agent system 100 extracts structured representations of successful execution sequences, parameter sets, and post-condition validations and transforms the structured representations into candidate playbooks. The autonomous software agent system 100 assigns candidate playbooks confidence scores based on repetition frequency, execution success rate, and user feedback. The autonomous software agent system 100 surfaces the candidate playbooks to a user computing device for approval prior to publication in the playbook library.

In one or more embodiments, the procedure section of a reusable system prompt (e.g., a playbook) includes one step per line, each line written imperatively. Moreover, in some embodiments, the procedure section of a reusable system prompt covers the entire scope of a software task and includes at least one step for setup, the actual task, and delivery. Further, in some embodiments, the procedure makes steps within a software task mutually exclusive and collectively exhaustive. In some embodiments, procedures help a user computing device define the order of an autonomous software agent's actions-like if/else/loops/go-to in code. Furthermore, in some embodiments, each procedure step contains an action verb (e.g., write, navigate to, etc.).

In one or more embodiments, the autonomous software agent system 100 includes is configured to track progression through procedural steps of a system prompt. For example, the autonomous software agent system 100 associates each procedural step with a step identifier, preconditions, post conditions, success criteria, failure criteria, and retry parameters. The state machine transitions between states comprising pending, in-progress, completed, failed, and paused states. In some embodiments, if a step fails based on detected execution errors, unmet post conditions, or invalid outputs, the autonomous software agent system 100 invokes a retry policy or escalates to the planner tool to generate corrective subtasks. In certain embodiments, the autonomous software agent system 100 supports resume-from-step functionality, allowing the autonomous software agent to continue execution from a previously completed state without repeating prior successfully executed steps. In some embodiments, the autonomous software agent system 100 represents procedural steps as a directed acyclic graph (DAG) of execution nodes, enabling conditional branching, parallelizable steps, and dependency enforcement between steps.

In one or more embodiments, a playbook supports conditional control flow logic. The autonomous software agent system 100 parses Boolean expressions defined within procedural steps and evaluates the expressions based on runtime state variables, user inputs, file existence checks, execution outputs, or environmental signals. Based on evaluation results, the autonomous software agent system 100 selectively transitions to alternative step branches. In some embodiments, the autonomous software agent system 100 configures playbooks with looping constructs with iteration limits and guard conditions to prevent infinite execution cycles. In this manner, playbooks may encode complex workflow logic beyond linear step execution.

Moreover, in some embodiments, a specifications section describes the post conditions of the playbook. In particular, a specifications section can include what is needed from a user computing device, such as anything necessary but outside of an autonomous software agent's control. For example, if the user computing device needs to provide a token or information that is not publicly available to the autonomous software agent.

In some embodiments, the autonomous software agent system 100 provides a plurality of reusable system prompts within a playbook library. Moreover, in some embodiments, the nature of the reusable system prompts is such that a user computing device can leverage them as system prompt templates (e.g., for playbook creation and optimization). In other words, the autonomous software agent system 100 provides for various modification options/iteration options of a system prompt to tailor the system prompt according to specific software design use cases of the user computing device.

In one or more embodiments, the autonomous software agent system 100 provides options for a user computing device to deploy multiple autonomous software agents to execute the same system prompt. In particular, the autonomous software agent system 100 provides this option such that a user computing device can efficiently/quickly identify potential errors within a system prompt. In other words, as alluded to above, the autonomous software agent system 100 can have the multiple autonomous software agents execute the same system prompt within different contexts and determine various deficiencies of a system prompt (e.g., a user computing device can modify the system prompt based on the actions of the autonomous software agents in response to executing the same system prompt).

For example, the autonomous software agent system 100 can deploy a first autonomous software agent and a second autonomous software agent to execute software tasks in different software contexts using the same system prompt. In particular, the autonomous software agent system 100 can generate (e.g., using the second autonomous software agent) one or more artificial intelligence outputs and surface the artificial intelligence outputs to a user computing device. In some embodiments, the autonomous software agent system 100 can receive a selection to pause the development session of the second autonomous software agent (e.g., based on the one or more artificial intelligence outputs surfaced to the user computing device).

Additionally, the autonomous software agent system 100 can receive one or more user inputs or modifications to the system prompt based on the one or more artificial intelligence outputs. In some embodiments, the autonomous software agent system 100 can make suggestions (e.g., artificial intelligence suggestions) for the user computing device to accept. In particular, the autonomous software agent system 100 can generate a modified system prompt based on user inputs or based on a user computing device accepting artificial intelligence suggestions. Moreover, in some embodiments, the autonomous software agent system 100 can resume the second autonomous software agent executing the software task according to a modified system prompt.

In one or more embodiments, the user computing device can further share advice and pointers with the autonomous software agent system 100 regarding execution of a system prompt. In particular, the autonomous software agent system 100 can receive a preferred way of completing tasks within the system prompt. Moreover, in one or more embodiments, the autonomous software agent system 100 can receive an indication that advice and points from the user computing device apply to an entire meta-task or to multiple sub-tasks. In some embodiments, the autonomous software agent system 100 can receive advice and pointers for a specific sub-task (e.g., written as a sub-bullet of the sub-task). Additionally, the autonomous software agent system 100 can receive advice via comments left on pseudocode within the system prompt (e.g., from the user computing device).

In some embodiments, the autonomous software agent system 100 collects analytics data for playbook usage. In other words, the autonomous software agent system 100 can track the frequency of a system prompt being selected and the performance of an autonomous software agent executing a system prompt. In some embodiments, the autonomous software agent system 100 can generate a suggestion for the user computing device to use a specific system prompt based on the analytics data.

The following illustrates an example of a reusable system prompt:

Playbook: R Data Science Tutorial
## Overview
Create a data science tutorial using an R markdown notebook.
## What's Needed From User
- Link to a dataset (csv file attachment)
- Specific task to create a data science tutorial for
## Procedure
1. Download the dataset provided by the user.
- If needed, download the dataset using a CLI - you do not need any credentials for this
2. Create an R markdown notebook titled ‘data_science_tutorial.Rmd.’
3. Create a ‘tmp.Rmd’ file for writing and saving intermediate code.
4. Create 5 main sections inside the ‘data_science_tutorial.Rmd’ file and add code from the
‘tmp.Rmd’ file containing the following:
- Dataset Statistics. Generate a statistical summary of the dataset.
- EDA (Exploratory Data Analysis). Create a bar chart and a scatter plot for the provided data.
- Train-test split. Split the data in an 80:20 ratio. Save the training and testing data.
- Training the machine learning model. Save the model once trained.
- Inference with the saved model. Load the saved model and evaluate its performance on the test
set using the metric specified by the user.
5. Once the code is written, add a short explanation for each section.
6. Convert the R markdown notebook to HTML format
7. Send the final R markdown notebook, HTML file, saved model and testing data to the user.
## Specifications
1. Send the R markdown notebook and HTML file to the user.
2. Send the saved model and testing data to the user.
## Advice and Pointers
1. Do not re-install packages if already installed.
2. Sign into RStudio is not required to complete this task.
3. Run the entire notebook after you add code for each section.
## Forbidden Actions
1. Do not overwrite the ‘data_science_tutorial.Rmd’ file.

In one or more embodiments, the autonomous software agent system 100 is configured to monitor tool invocation requests generated by the autonomous software agent. Prior to executing a shell command, browser navigation action, or file modification operation, the autonomous software agent system 100 evaluates the requested action against forbidden action constraints defined within the playbook. If a violation is detected, the autonomous software agent system 100 blocks execution and generates a corrective instruction to the planner tool 314. In some embodiments, the autonomous software agent system 100 additionally enforces sandbox restrictions, file system boundaries, network domain allowlists, and rate limits.

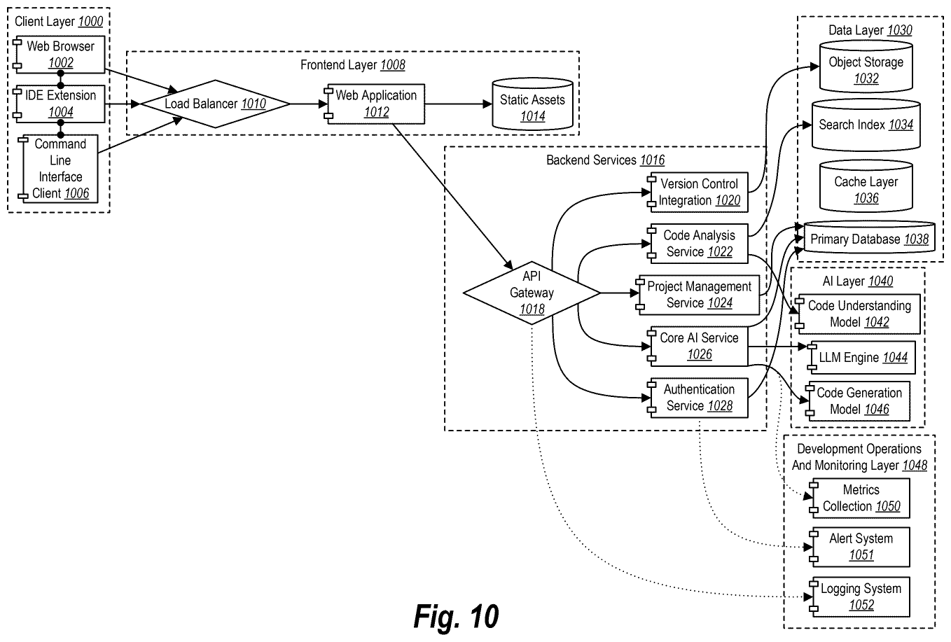

FIG. 10 illustrates architectural details of the autonomous software agent system 100 using one or more machine learning models in accordance with one or more embodiments. In particular, the autonomous software agent system 100 deploys an autonomous software agent with a plurality of computer software composition tools, generates one or more artificial intelligence outputs responsive to a software task, and provides responses to prompts submitted via an interface.

As shown in FIG. 10, the autonomous software agent system 100 contains a client layer 1000 (e.g., with a web browser 1002, an IDE extension 1004, and a command line interface client 1006), a frontend layer 1008 with a load balancer 1010 (e.g., which is a system to distribute incoming traffic across multiple servers which optimizes efficiency), a web application 1012 (e.g., a Devin web application that shows a chat interface and the fully featured software composition tools of the autonomous software agent), and static assets 1014 (e.g., files that do not dynamically change based on user interactions, such as HTML files, CSS files, JavaScript files, images, etc.).

Moreover, FIG. 10 shows the autonomous software agent system 100 also contains backend services 1016 with an API gateway 1018 (e.g., which is a single entry point for managing and routing API requests from client devices to different microservices/backend systems), a version control integration 1020 (e.g., a backend service application to track changes to code such as a connected code repository application part of a code repository management system), a code analysis service 1022, a project management service 1024 (e.g., a software system to track the development of various tasks that a software development team is working on), a core AI service 1026 (e.g., artificial intelligence modules or tools to handle the use of machine learning models, natural language processing, and other artificial intelligence tasks), and an authentication service 1028 (e.g., to check for valid authentication credentials).

In particular, the backend services 1016 include applications that all communicate with the backend web-server of the autonomous software agent system 100, which performs the job of deploying autonomous software agents, and orchestrating/managing sessions (Devin sessions), as well as providing the APIs to display data about the autonomous software agent system 100 on various computing devices, generating artificial intelligence outputs, orchestrating the execution of software tasks by accessing a plurality of software composition tools, providing a plurality of interactive tools to a user computing device. In particular, the backend services 1016 of the autonomous software agent system 100 manage the generation of artificial intelligence outputs for executing a software task of a development session.

For example, the backend services 1016 perform the job of enabling request decomposition, artificial intelligence plan generation, terminal command generation, computer code generation, navigation actions, software task orchestration, and interactive tools of the autonomous software agent. In particular, the client layer 1000, the frontend layer 1008 and the backend services 1016 are in consistent communication with one another to notify each service regarding any input received from a user computing device (e.g., via a chat interface and/or user intervention via interactive tools). Thus, this enables the autonomous software agent system 100 to immediately transfer that input/context to a deployed autonomous software agent.

Further, FIG. 10 shows a data layer 1030 with object storage 1032 (e.g., which is storage of unstructured data), a search index 1034 (e.g., an index of one or more code repositories), a cache layer 1036 (e.g., a layer that temporarily holds frequently accessed or recently computed data), and a primary database 1038 (e.g., a central data store to hold application data). Moreover, FIG. 10 shows an AI layer 1040 with a code understanding model 1042, an LLM engine 1044, and a code generation model 1046. Moreover, FIG. 10 shows a development operations and monitoring layer 1048 (e.g., with metrics collection 1050, an alert system 1051, and a logging system 1052).

As shown in FIG. 10, the autonomous software agent system 100 utilizes the AI layer 1040 to perform a variety of reasoning/generation tasks. In particular, the autonomous software agent system 100 accesses the AI layer 1040 every time a code repository is connected or updated, or a new session is spun up (e.g., each time a new development box is activated). In order to enable the AI layer 1040, the autonomous software agent system 100 provides various onboarding tools to a user computing device. In particular, the onboarding tools allow a user to provide access to a code repository provider (e.g., a Gitprovider), select repositories, assign read access, and assign write access.

In some embodiments, the autonomous software agent system 100 prompts a user computing device for additional access permissions. In particular, the autonomous software agent system 100 can prompt the user for additional access permissions after generating a response to a prompt or during an autonomous software agent session. For example, the autonomous software agent system 100 determines during generating a response or executing software coding tasks that additional knowledge/permissions are needed to more thoroughly respond/perform a task.

As further shown in FIG. 10, the AI layer 1040 of the autonomous software agent system 100 further includes the code understanding model 1042. In particular, the code understanding model 1042 analyzes computer code. In other words, the autonomous software agent system 100 seeks to understand the context and background of a code base/repository to generate an index of the code repository (e.g., to more effectively perform software coding tasks as a driver and not merely as a co-pilot).

In some embodiments, the autonomous software agent system 100 extracts contextual data from information provided by a user to generate an index using the code understanding model 1042. To illustrate, the autonomous software agent system 100 parses through a code repository and generates abstraction summaries using the code understanding model 1042 and one or more additional artificial intelligence models (e.g., such as the LLM engine).

Moreover, the autonomous software agent system 100 utilizes the AI layer 1040 to enable AI-native features in a planner interface, a chat interface, or a configuration interface of an autonomous software agent. In particular, the autonomous software agent system 100 provides the AI-native features as options for a user computing device to activate during configuration or during interaction with the autonomous software agent system 100.

In some embodiments, the autonomous software agent system 100 uses the AI layer 1040 to ingest data from a code base and further utilizes the code understanding model 1042 to generate output predictions related to the context of the code base. For example, the autonomous software agent system 100 connects to code repositories and creates knowledge inputs/suggestions based on processing the information in the code repository.

To illustrate, the autonomous software agent system 100 can read through documentation/specifications and distill that information into data that is relevant for the code understanding model 1042 of the autonomous software agent system 100. In addition, after generating the index of the code repository, the autonomous software agent system 100 further stores the index in the data layer 1030 and/or uses the development operations and monitoring layer 1048 to monitor changes/thresholds related to the connected code repository. This allows the autonomous software agent system 100 to more effectively execute software coding tasks when deploying an autonomous software agent.

Moreover, after generating the index of the code repository, the autonomous software agent system 100 further generates responses to prompts. In some embodiments, the autonomous software agent system 100 receives prompts from the frontend layer 1008 submitted via an interface (or where the autonomous software agent system 100 intakes a prompt, whether via the web application, a messaging application, or otherwise) and are sent to the backend services 1016 of the autonomous software agent system 100, where the prompt is processed by the one or more artificial intelligence components (e.g., Devin's brain).

As shown in FIG. 10, the autonomous software agent system 100 utilizes the client layer 1000 to receive interactions. In particular, users can submit a prompt of a question regarding a current development session, past development session, a code repository, etc. via a Devin messaging application integration, an application programming interface call, or directly through a web browser application of the intelligent search interface. In some embodiments, the messaging application integration lets users prompt the autonomous software agent system 100 and to further create sessions by tagging an autonomous software agent in their team's messaging server.

As just mentioned, the messaging application integration allows for development sessions to be created by tagging/mentioning an autonomous software agent. In some embodiments, the autonomous software agent system 100 receives from a third-party messaging application between a plurality of users, a mention that tags the autonomous software agent to execute the software task. Additionally, the autonomous software agent system 100 transmits the mention that tags the autonomous software agent to a virtual private cloud that hosts the independent virtual. This is shown in more detail below.

In some embodiments, as shown, the autonomous software agent system 100 utilizes the LLM engine 1044 (e.g., a model that selects one or more large language models according to certain parameters/requirements) of an autonomous software agent to generate a response to a prompt. In particular, the autonomous software agent system 100 calls a first large language model for a first task (e.g., generating a first result for a prompt) and a second large language model for a second task (generating a second result for the prompt).

In one or more embodiments, the autonomous software agent system 100 utilizes the complex architectural design shown in FIG. 10. In particular, the autonomous software agent system 100 includes a natural language processing component (e.g., Devin's Brain) that allows the autonomous software agent system 100 to understand natural language descriptions (e.g., the functionalities of desired software programs). In some embodiments, the autonomous software agent system 100 utilizes natural language processing to analyze natural language descriptions in a prompt and to extract key functionalities and requirements.

In one or more embodiments, the autonomous software agent system 100 generates an index of a code repository (e.g., accessible by an autonomous software agent) as described in application Ser. No. 19/224,222 PROVIDING INTELLIGENT SEARCH FUNCTIONALITY OF A CODE REPOSITORY VIA AN AUTONOMOUS SOFTWARE AGENT which was filed on May 30, 2025, and is fully incorporated by reference herein.

As mentioned above, in some embodiments, the autonomous software agent system 100 generates a response to the prompt and uses the context from the response to deploy an autonomous software agent. In some embodiments, the autonomous software agent system 100 uses the autonomous software agent system 100 to spin up a development box, where each spun up development box contains knowledge and the autonomous software agent system from one session to another does not transfer the knowledge over to the next session. In some embodiments, knowledge is a form of “information” that allows the autonomous software agent system 100 to retrieve information based on specific triggers that might be relevant to the session. As also mentioned, this knowledge (depending on the trigger) is retrievable across all sessions.

In one or more embodiments, a playbook includes a dependency declaration section specifying required runtime environments, programming languages, package dependencies, environment variables, hardware constraints, or network access permissions. Upon receiving a selected playbook, the autonomous software agent system 100 selects a base virtual machine template that satisfies the declared dependencies. In some embodiments, the autonomous software agent system 100 provisions the independent virtual machine computing environment by installing required packages, configuring environment variables, and validating tool availability prior to execution. In certain embodiments, the dependency declaration section further specifies minimum tool capability requirements, including required shell tool features, browser tool permissions, or integrated development environment extensions. In one or more embodiments, the autonomous software agent system 100 verifies tool compatibility prior to initiating the development session.

As mentioned above, the autonomous software agent system 100 uses the autonomous software agent system 100 which deploys autonomous software agents that have access to their own machines. In particular, for each new spun up session, the autonomous software agent system 100 spins up a new development box (e.g., sandbox) which includes a fully featured IDE (shell, an editor, a browser, etc.). Moreover, the autonomous software agent system 100 allows a development box to be customized in a user's workspace (e.g., Devin's Workspace), where the user can save a specific machine snapshot that the autonomous software agent system 100 will use each time it spins up a new development box.

Furthermore, the autonomous software agent system generates development boxes that are isolated virtual machines. In particular, the development boxes run on top of a custom hypervisor implemented to support the virtual machine technology. Moreover, the state of a run (e.g., deploying an autonomous software agent) can be rolled-back to an earlier point in time. In rolling back to an earlier point in time, the autonomous software agent system 100 rolls back both the state of “Devin's brain” (e.g., the knowledge and the progress on a certain task), as well as the state of Devin's machine (e.g., the machine contents).

Moreover, in some embodiments, the autonomous software agent system 100 offers a virtual private cloud (VPC) deployment solution that allows development boxes to run within a customer's (a set of users) cloud tenant with the “Devin brain” (e.g., a component of the autonomous software agent) interacting with the development boxes over a secure tunnel. All data related to sessions are stored at rest in the customer cloud tenant.

Furthermore, each of these development boxes (or sessions) can speak to the customer-hosted services (connected via API integrations). Accordingly, the autonomous software agent system 100 can leverage the AI layer 1040, the data layer 1030, the backend services 1016, and the frontend layer 1008 to cause the graphical user interface on the user computing device to display the actions taken by the autonomous software agent (e.g., the actions via the software composition tools of the autonomous software agent).

Further, as already mentioned, the autonomous software agent system 100 includes machine learning models. In particular, the autonomous software agent system 100 utilizes pre-trained machine learning models to translate descriptions (e.g., from a response to a prompt) into artificial intelligence outputs (e.g., artificial intelligence plans, computer code, terminal commands, navigation actions, etc.). Moreover, the machine learning models utilized by the autonomous software agent system 100 have been trained on vast amounts of computer code data, which allows them to identify patterns and generate functional code. In some embodiments, the autonomous software agent system 100 utilizes the machine learning models to process the extracted information (e.g., key functionalities and requirements). In particular, the autonomous software agent system 100 utilizes the machine learning models to search for patterns and identify similar code structures from their training data.

Additionally, the autonomous software agent system 100 includes the code generation model 1046. In particular, based on processed information from the natural language processing and the machine learning models, the autonomous software agent system 100 translates the descriptions into actual computer code. In other words, the output of the natural language processing and the machine learning model is pulled into the code generation engine to create viable computer code. In some embodiments, based on identified patterns, the autonomous software agent system 100 utilizes the code generation engine to create functional code responsive to deploying an autonomous software agent after generating a response to a prompt.

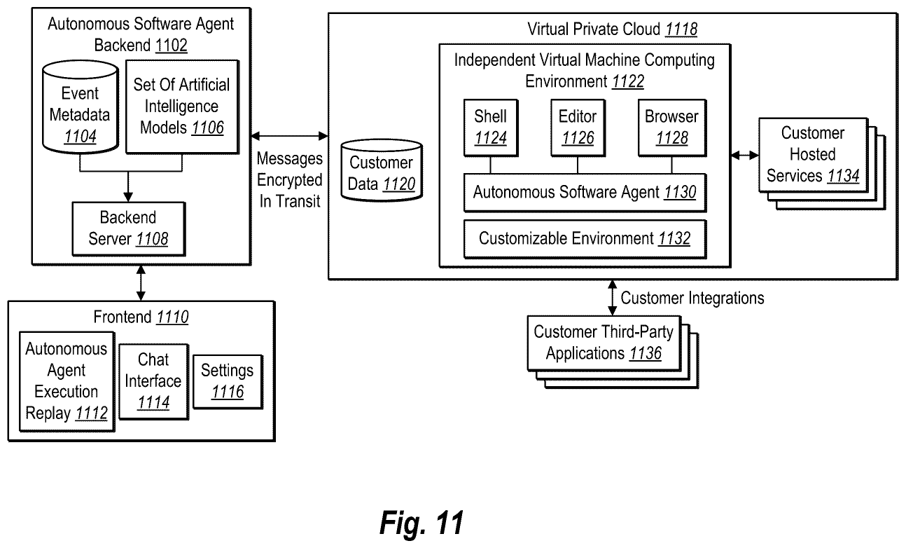

FIG. 11 illustrates additional details of the architecture of the autonomous software agent system 100 in accordance with one or more embodiments. For example, FIG. 11 shows that for each session of deploying an autonomous software agent, the autonomous software agent system 100 spins up/deploys an autonomous software agent backend 1102 that includes a “backend container” paired with “a development box” virtual machine. In other words, the autonomous software agent system 100 initializes a development box (e.g., an independent virtual machine computing environment) with an autonomous software agent backend that includes a set of artificial intelligence models 1106. As mentioned above, the set of artificial intelligence models 1106 contains one or more machine learning/artificial intelligence models shown above used to process, analyze, and generate data.

As shown in FIG. 11, the autonomous software agent backend 1102 includes event metadata 1104 (e.g., context surrounding a prompt/request submitted to a web application interface, a response to the prompt, or other external sources that contain contextual data), the set of artificial intelligence models 1106 (e.g., one or more machine learning models shown and discussed in FIG. 10), and a backend server 1108 (e.g., a server that handles logic, database interactions, authentication, and other services for deploying an autonomous software agent).

Further, FIG. 11 shows the autonomous software agent backend 1102 interacting with a frontend 1110 which includes autonomous agent execution replay 1112 (e.g., replay for a timelapse of a development session, a session replay that is a recording of previous user interactions with the autonomous software agent system 100), chat UI 1114 (e.g., the graphical user interface provided to a user to submit prompts), and settings 1116 (e.g., custom settings established by the autonomous software agent system 100 or by a user).

Moreover, the autonomous software agent backend 1102 communicates with a virtual private cloud 1118 (e.g., a customer virtual private cloud, which is a dedicated and isolated virtual network within a public cloud service) via encrypted messages. In particular, FIG. 11 shows an independent virtual machine computing environment 1122 hosted on the virtual private cloud 1118 and the virtual private cloud 1118 further includes customer data 1120.

Additionally, the independent virtual machine computing environment 1122 further includes a shell 1124, an editor 1126 (e.g., integrated development environment), a browser 1128, an autonomous software agent 1130, a customizable environment 1132 (e.g., playbooks, knowledge, etc. that customize an independent virtual machine computing environment) and customer hosted services 1134 (e.g., services or applications hosted and managed by a tenant organization). Additionally, FIG. 11 shows that the virtual private cloud 1118 can integrate various applications via access tokens/API keys. In particular, the autonomous software agent system can use the independent virtual machine computing environment 1122 (e.g., the autonomous software agent) to write various code and make integrations with applications integrated with the virtual private cloud 1118 (e.g., customer third-party applications 1136).

In one or more embodiments, the autonomous software agent system 100 utilizes communication between the virtual private cloud 1118 and the autonomous software agent backend 1102 (e.g., that includes the set of artificial intelligence models 1106) to transmit a selected reusable system prompt and/or guidance instructions. In particular, in the context of the above discussion, the autonomous software agent system 100 transmits the selected reusable system prompt and/or guidance instructions to the autonomous software agent backend 1102 to determine an artificial intelligence plan. Accordingly, a development session involves the autonomous software agent system 100 leveraging (e.g., initializing) the independent virtual machine computing environment 1122 paired with the autonomous software agent backend 1102.

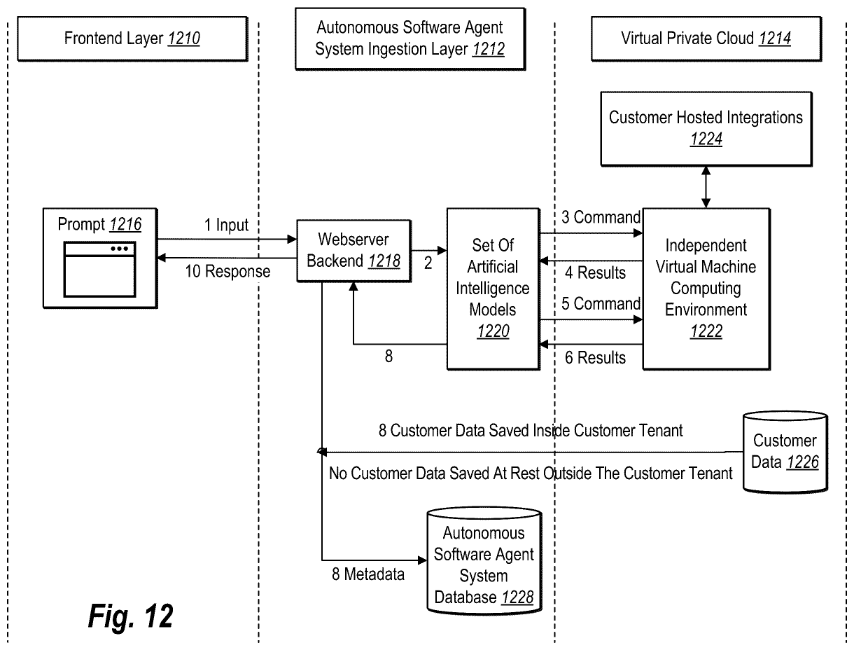

Further, FIG. 12 shows that the autonomous software agent system 100 receives a prompt 1216 via a frontend layer 1210. As shown, the autonomous software agent system 100 passes the prompt 1216 to an autonomous software agent system ingestion layer 1212. In response to the prompt 1216, the autonomous software agent system 100 responds to the prompt 1216 with a webserver backend 1218 and further passes the information to a set of artificial intelligence models 1220 (e.g., one or more artificial intelligence models shown above in FIG. 10).

As further shown in FIG. 12, the autonomous software agent system 100 passes commands/results back and forth between a virtual private cloud 1214 (e.g., an independent virtual machine computing environment 1222) and the set of artificial intelligence models 1220. In other words, FIG. 12 illustrates the interaction between the frontend layer 1210 of the autonomous software agent system 100, the backend of the autonomous software agent system 100, and an autonomous software agent deployed for performing tasks at the virtual private cloud 1214. Furthermore, the independent virtual machine computing environment 1222 also accesses customer hosted integrations 1224 at the virtual private cloud 1214.

Additionally, FIG. 12 shows customer data 1226 at the virtual private cloud 1214 which the autonomous software agent system 100 passes all customer data saved inside the customer tenant to the tenant (e.g., and no customer data is saved at rest outside the customer tenant). Moreover, FIG. 12 shows the autonomous software agent system 100 using the webserver backend 1218 to pass metadata to an autonomous software agent system database 1228.

In one or more embodiments, the autonomous software agent system 100 receives an autonomous software agent prompt and deploys an autonomous software agent, which includes one or more machine learning components (e.g., large language models). In one or more embodiments, the autonomous software agent system 100 utilizes a text encoder to generate a set of text tokens for the autonomous software agent prompt.

Moreover, based on the text tokens, the autonomous software agent system 100 generates an artificial intelligence plan (e.g., breaks down the software task), and further reasons how to complete one or more tasks. In particular, the autonomous software agent system uses the independent virtual machine computing environment 1222 to communicate with the set of artificial intelligence models 1220 (e.g., the artificial intelligence components shown in FIG. 10) to determine which shell commands to make, computer code to write (e.g., in the editor), and webpages to browse.

In one or more embodiments, the autonomous software agent system 100 further utilizes a text encoder to process a prompt/request to deploy an autonomous software agent. In particular, the text encoder includes a component of a neural network to transform textual data (e.g., the text prompt) into a numerical representation. For instance, the autonomous software agent system 100 utilizes the text encoder to transform the prompt into a text encoding (e.g., text tokens). Further, the autonomous software agent system 100 utilizes the text encoder in a variety of ways.

For instance, the autonomous software agent system 100 utilizes the text encoder to i) determine the frequency of individual words in the text prompt (e.g., each word becomes a feature vector), ii) determine a weight for each word within the text prompt to generate a text vector that captures the importance of words within a text prompt, iii) generate low-dimensional text vectors in a continuous vector space that represents words within the text prompt, and/or iv) generate contextualized text vectors by determining semantic relationships between words within the text prompt.

Furthermore, although not shown in FIGS. 10-12, in one or more embodiments, the autonomous software agent system trains the set of artificial intelligence models 1220 (e.g., artificial intelligence components such as the code generation engine, the natural language processing, and the machine learning models). For example, the autonomous software agent system 100 leverages a set of large language models and fine-tunes each large language model for different tasks. In particular, the autonomous software agent system 100 has a large language model for terminal requests, a large language model for generating computer code, a large language model for generating a plan, and a large language model for performing website browsing actions and determining a relevance of certain portions of a website domain page.

Moreover, the autonomous software agent system 100 trains the set of artificial intelligence models 1220 by sending an input task to one or more of the large language models, generates a prediction for the input task, and compares the prediction with a ground truth reference. Based on the comparison, the autonomous software agent system 100 fine-tunes or modifies parameters of one or more large language models (e.g., that are part of the set of artificial intelligence models 1220). Thus, at inference time, the autonomous software agent system 100 performs advanced reasoning tasks fine-tuned for specific use cases.

In addition, as alluded to above, the autonomous software agent system 100 trains machine learning models to translate descriptions into code. In some embodiments, the autonomous software agent system 100 trains multiple machine learning models for discrete tasks. In particular, the autonomous software agent system 100 trains a machine learning model to generate specific types of functional code. For example, the autonomous software agent system 100 utilizes a machine learning model to generate computer code from a description and compares the description to a ground truth reference and fine-tunes/modifies parameters of the machine learning model.

Moreover, the autonomous software agent system 100 further continuously learns from feedback and developer interactions. In particular, the autonomous software agent system 100 deploys autonomous software agents that perform a variety of tasks, and in response to prompts and/or feedback (e.g., user intervention), the autonomous software agent system 100 learns from the interactions to improve its capabilities. In other words, the autonomous software agent system 100 fine-tunes the artificial intelligence components in response to updates/feedback received from users.

FIGS. 11-12 describe various architectural details of the autonomous software agent system 100. In particular, the architectural components of the autonomous software agent system 100 enable an autonomous software agent to perform a variety of tasks. To illustrate, the autonomous software agent system 100 performs repetitive coding tasks such as generating boilerplate code, data validation routines, and unit tests.

Moreover, the autonomous software agent system 100 performs code reviews (e.g., one or more software developers examine code written by others to identify potential issues and provide feedback) and debugging such as analyzing code to identify potential bugs and suggesting fixes/improvements. Furthermore, the autonomous software agent system 100 performs deployment automation to automate a deployment process of software (e.g., streamlining the transition from development to production).

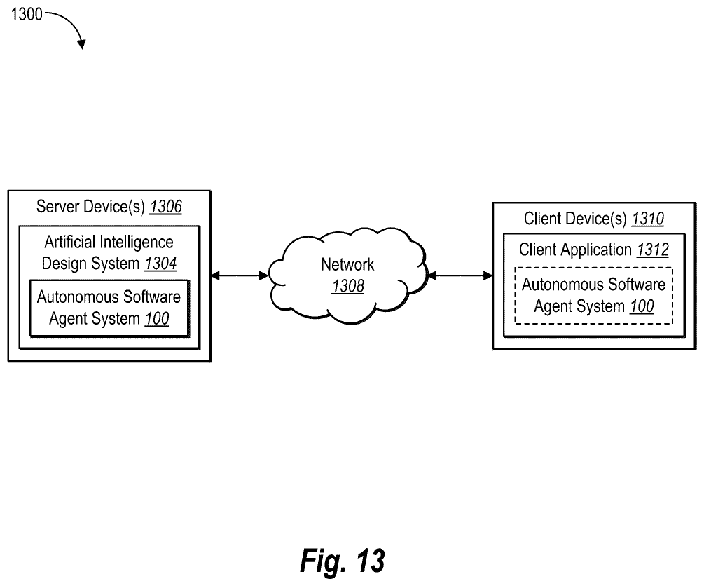

Additional details regarding the autonomous software agent system 100 will now be provided with reference to the figures. For example, FIG. 13 illustrates a schematic diagram of an exemplary system environment 1300 in which an autonomous software agent system 100 operates. As illustrated in FIG. 13, the system environment 1300 includes server device(s) 1306, an artificial intelligence design system 1304, a network 1308, and client device(s) 1310. Additionally, FIG. 13 illustrates that the artificial intelligence design system 1304 includes the autonomous software agent system 100.

Although the system environment 1300 of FIG. 13 is depicted as having a particular number of components, the system environment 1300 is capable of having a different number of additional or alternative components (e.g., a different number of servers, client devices, or other components in communication with the autonomous software agent system 100 via the network 1308). Similarly, although FIG. 13 illustrates a particular arrangement of the server device(s) 1306, the network 1308, and the client device(s) 1310, various additional arrangements are possible.

The server device(s) 1306, the network 1308, and the client device(s) 1310 are communicatively coupled with each other either directly or indirectly (e.g., through the network 1308 discussed in greater detail below). Moreover, the server device(s) 1306 and the client device(s) 1310 include one or more of a variety of computing devices (including one or more computing devices as discussed in greater detail below).

As mentioned above, the system environment 1300 includes the server device(s) 1306. In one or more embodiments, the server device(s) 1306 process input for a request (e.g., a request to configure an autonomous software agent or to deploy an autonomous software agent). In one or more embodiments, the server device(s) 1306 comprise a data server. In some implementations, the server device(s) 1306 comprise a communication server or a web-hosting server. Furthermore, the server device(s) 1306 can be associated with the autonomous software agent system 100 or with an organization/company that deploys the autonomous software agent system 100.

In some embodiments, the client device(s) 1310 includes computing devices associated with the one or more user accounts that submit requests for the autonomous software agent system 100. In some embodiments, the autonomous software agent system 100 trains one or more artificial intelligence models such as a code understanding model, one or more large language models, and a code generation model.

In one or more embodiments, the client device(s) 1310 includes smartphones, tablets, desktop computers, laptop computers, head-mounted-display devices, or other electronic devices. The client device(s) 1310 includes one or more software applications (e.g., the client application 1312) for generating content in accordance with the artificial intelligence design system 1304. In one or more embodiments, the client application 1312 includes a software application hosted on the server device(s) 1306 accessible by the client device(s) 1310 through another application, such as a web browser.

To provide an example implementation, in some embodiments, the autonomous software agent system 100 on the server device(s) 1306 supports the autonomous software agent system 100 on the client device(s) 1310. For instance, in some cases, the artificial intelligence design system 1304 on the server device(s) 1306 gathers data for the autonomous software agent system 100. In response, the autonomous software agent system 100, via the server device(s) 1306, provides the information to the client device(s) 1310. In other words, the client device(s) 1310 obtains (e.g., downloads) the autonomous software agent system 100 from the server device(s) 1306 that is already trained/optimized. Once downloaded, the autonomous software agent system 100 on the client device(s) 1310 is able to perform tasks (e.g., generative software tasks) independent from the server device(s) 1306. In one or more alternative implementations, the autonomous software agent system 100 generates or learns parameters for one or more artificial intelligence models (e.g., used to implement an autonomous software agent) in whole or in part on the client device(s) 1310.

In alternative implementations, the artificial intelligence design system 1304 includes a web hosting application that allows the client device(s) 1310 to interact with content and services hosted on the server device(s) 1306. To illustrate, in one or more implementations, the client device(s) 1310 accesses a software application supported by the server device(s) 1306. In response, the artificial intelligence design system 1304 on the server device(s) 1306 provides tools for monitoring/modifying/generating computer code using the autonomous software agent. In other words, the client device(s) 1310 does not have to download the autonomous software agent system 100 while still being able to access/utilize the trained/optimized tools provided by the artificial intelligence design system 1304 via a web hosting application.

In some embodiments, the autonomous software agent system 100 is implemented in whole, or in part, by the individual elements of the system environment 1300. For instance, although FIG. 13 illustrates the autonomous software agent system 100 implemented or hosted on the server device(s) 1306, different components of the autonomous software agent system 100 are able to be implemented by a variety of devices within the system environment 1300. For example, one or more (or all) components of the autonomous software agent system 100 are implemented by a different computing device or a separate server from the server device(s) 1306. Indeed, as shown in FIG. 13, the client device(s) 1310 includes the autonomous software agent system 100.

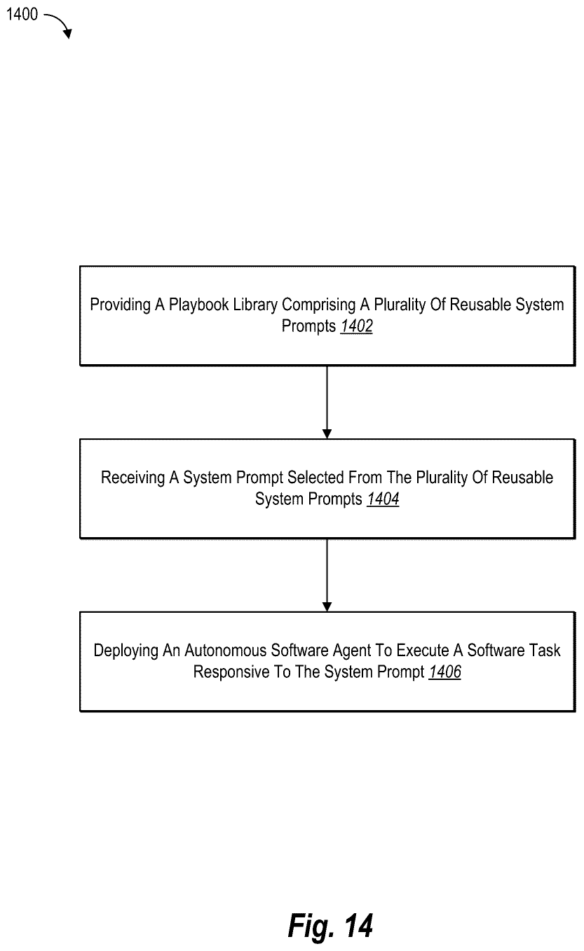

FIG. 14 illustrates a flowchart of a series of acts 1400 for deploying an autonomous software agent to execute a software task responsive to a system prompt in accordance with one or more embodiments. FIG. 14 illustrates acts according to one embodiment, alternative embodiments may omit, add to, reorder, and/or modify any of the acts shown in FIG. 14. In some implementations, the acts of FIG. 14 are performed as part of a method. For example, in some embodiments, the acts of FIG. 14 are performed as part of a computer-implemented method. Alternatively, a non-transitory computer-readable medium stores instructions thereon that, when executed by at least one processor, cause a computing device to perform the acts of FIG. 14. In some embodiments, a system performs the acts of FIG. 14. For example, in one or more embodiments, a system includes at least one memory device. The system further includes at least one server device configured to cause the system to perform the acts of FIG. 14.

The series of acts 1400 includes an act 1402 of providing a playbook library comprising a plurality of reusable system prompts. Further, the series of acts 1400 includes an act 1404 of receiving a system prompt selected from the plurality of reusable system prompts. Moreover, the series of acts 1400 includes an act 1406 of deploying an autonomous software agent to execute a software task responsive to the system prompt.

In particular, the act 1402 includes providing, for display via a graphical user interface, a playbook library comprising a plurality of reusable system prompts. Further, the act 1404 includes receiving, via the graphical user interface, a system prompt selected from the plurality of reusable system prompts. Moreover, the act 1406 includes deploying an autonomous software agent, which operates within an independent virtual machine computing environment, to execute a software task responsive to the system prompt selected from the playbook library. The series of acts 1400 further includes the below clauses.
Clause 1. A computer-implemented method comprising: providing, for display via a graphical user interface, a playbook library comprising a plurality of reusable system prompts; receiving, via the graphical user interface, a system prompt selected from the plurality of reusable system prompts; and deploying an autonomous software agent, which operates within an independent virtual machine computing environment, to execute a software task responsive to the system prompt selected from the playbook library.
Clause 2. The computer-implemented method of clause 1, further comprising executing, utilizing the autonomous software agent, the system prompt comprising a procedure outlining a scope of the software task and specifications that describe post conditions of executing the software task.
Clause 3. The computer-implemented method of any of clauses 1-2, further comprising executing, utilizing the autonomous software agent, the system prompt comprising forbidden actions, tips to correct actions from previous development sessions, and required user inputs to execute the software task according to the system prompt.
Clause 4. The computer-implemented method of any of clauses 1-3, wherein deploying the autonomous software agent further comprises: providing a plurality of software composition tools for the autonomous software agent to access within the independent virtual machine computing environment, wherein the plurality of software composition tools comprise a shell tool, a browser tool, an integrated development environment, and a planner tool.
Clause 5. The computer-implemented method of any of clauses 1-4, wherein receiving the system prompt further comprises: providing, for display via the graphical user interface, an autonomous software agent chat interface; and receiving, via the graphical user interface, guidance instructions and the system prompt selected from the plurality of reusable system prompts.
Clause 6. The computer-implemented method of any of clauses 1-5, further comprising: generating, by the autonomous software agent and utilizing a planner tool, an artificial intelligence plan based on the guidance instructions and the system prompt; and providing, for display via the graphical user interface, a first option to modify the artificial intelligence plan or a second option to confirm the artificial intelligence plan.
Clause 7. The computer-implemented method of any of clauses 1-6, wherein receiving the system prompt further comprises: providing, for display via the graphical user interface, an autonomous software agent chat interface; receiving, via the graphical user interface, guidance instructions, an attached file, and the system prompt selected from the plurality of reusable system prompts; and generating, by the autonomous software agent and utilizing a planner tool, an artificial intelligence plan based on the guidance instructions and customizing the system prompt according to the attached file.
Clause 8. The computer-implemented method of any of clauses 1-7, further comprising deploying multiple autonomous software agents, which operate within independent virtual machine computing environments to execute one or more software tasks each in a different context responsive to the system prompt selected from the playbook library.
Clause 9. A system comprising: one or more memory devices; and one or more processors coupled to the one or more memory devices, configured to cause the system to: provide, for display via a graphical user interface, a playbook library comprising a plurality of reusable system prompts; in response to receiving a selection of a new system prompt option, receive an additional system prompt to save in the playbook library from the graphical user interface, wherein the additional system prompt comprises a procedure outlining a scope of a software task and specifications that describe post conditions of executing the software task; receive, from the graphical user interface, the additional system prompt selected from the plurality of reusable system prompts; and deploy an autonomous software agent, which operates within an independent virtual machine computing environment, to execute a software task responsive to the additional system prompt selected from the playbook library.
Clause 10. The system of clause 9, wherein the one or more processors are configured to cause the system to: provide, for display via the graphical user interface, the plurality of reusable system prompts with modification options to modify the plurality of reusable system prompts; receive, via the graphical user interface, a selection of a modification option to modify a reusable system prompt; and save a modified reusable system prompt to the playbook library based on the selection of the modification option.
Clause 11. The system of any of clauses 9-10, wherein the one or more processors are configured to cause the system to: provide, for display via the graphical user interface, an autonomous software agent chat interface; receive, via the graphical user interface, guidance instructions and the additional system prompt selected from the plurality of reusable system prompts; and customize the additional system prompt according to the guidance instructions.
Clause 12. The system of any of clauses 9-11, wherein the one or more processors are configured to cause the system to: execute, utilizing the autonomous software agent, the additional system prompt comprising a procedure outlining a scope of the software task and specifications that describe post conditions of executing the software task; and execute, utilizing the autonomous software agent, the additional system prompt comprising forbidden actions, tips to correct actions from previous development sessions, and required user inputs to execute the software task according to the additional system prompt.
Clause 13. The system of any of clauses 9-12, wherein the one or more processors are configured to cause the system to deploy the autonomous software agent by: providing a plurality of software composition tools for the autonomous software agent to access within the independent virtual machine computing environment, wherein the plurality of software composition tools comprise a shell tool, a browser tool, an integrated development environment, and a planner tool; and generating, by the autonomous software agent and utilizing a planner tool, an artificial intelligence plan based on the additional system prompt.
Clause 14. The system of any of clauses 9-13, wherein the one or more processors are configured to cause the system to deploy the autonomous software agent by: initializing a development session comprising the independent virtual machine computing environment hosted on a virtual private cloud and an autonomous agent model backend comprising a set of large language models; and transmitting, from executing the software task according to the additional system prompt, encrypted communications between the virtual private cloud that hosts the independent virtual machine computing environment and the autonomous agent model backend.
Clause 15. The system of any of clauses 9-14, wherein the one or more processors are configured to cause the system to: deploy the autonomous software agent, which operates within the independent virtual machine computing environment, to execute the software task responsive to the additional system prompt in a first software context; and deploy an additional autonomous software agent, which operates within an additional independent virtual machine computing environment, to execute an additional software task responsive to the additional system prompt in a second software context.

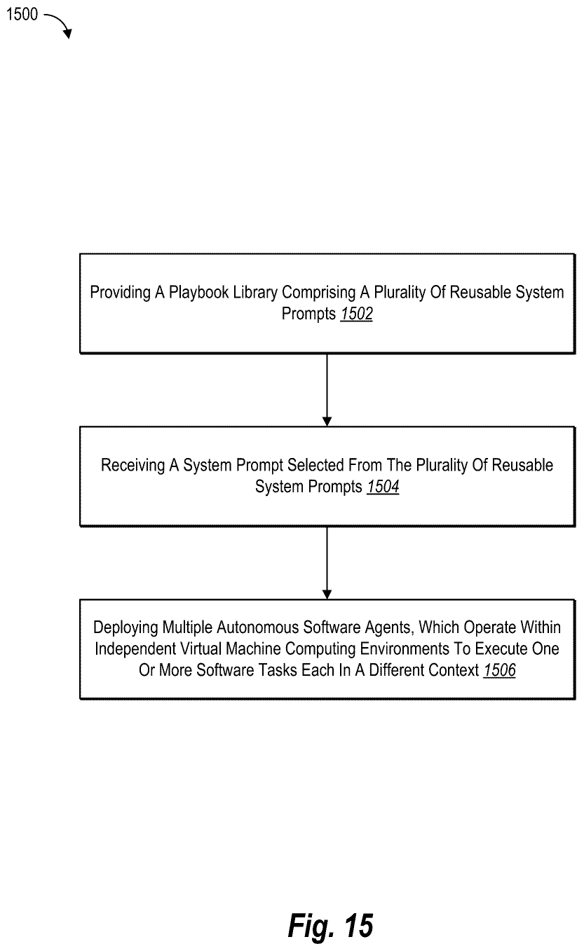

FIG. 15 illustrates a flowchart of a series of acts 1500 for deploying multiple autonomous software agents to execute one or more software tasks each in a different context in accordance with one or more embodiments. FIG. 15 illustrates acts according to one embodiment, alternative embodiments may omit, add to, reorder, and/or modify any of the acts shown in FIG. 15. In some implementations, the acts of FIG. 15 are performed as part of a method. For example, in some embodiments, the acts of FIG. 15 are performed as part of a computer-implemented method. Alternatively, a non-transitory computer-readable medium stores instructions thereon that, when executed by at least one processor, cause a computing device to perform the acts of FIG. 15. In some embodiments, a system performs the acts of FIG. 15. For example, in one or more embodiments, a system includes at least one memory device. The system further includes at least one server device configured to cause the system to perform the acts of FIG. 15.

The series of acts 1500 includes an act 1502 of providing a playbook library comprising a plurality of reusable system prompts. Further, the series of acts 1500 includes an act 1504 of receiving a system prompt selected from the plurality of reusable system prompts. Moreover, the series of acts 1500 includes an act 1506 of deploying multiple autonomous software agents, which operate within independent virtual machine computing environments to execute one or more software tasks each in a different context.

In particular, the act 1502 includes providing, for display via a graphical user interface, a playbook library comprising a plurality of reusable system prompts. Further, the act 1504 includes receiving, from the graphical user interface, a system prompt selected from the plurality of reusable system prompts. Moreover, the act 1506 includes deploying multiple autonomous software agents, which operate within independent virtual machine computing environments to execute one or more software tasks each in a different context responsive to the system prompt selected from the playbook library. The series of acts 1500 further includes the following clauses.
Clause 16. A non-transitory computer-readable medium storing executable instructions which, when executed by at least one processing device, cause the at least one processing device to perform operations comprising: providing, for display via a graphical user interface, a playbook library comprising a plurality of reusable system prompts; receiving, from the graphical user interface, a system prompt selected from the plurality of reusable system prompts; and deploying multiple autonomous software agents, which operate within independent virtual machine computing environments to execute one or more software tasks each in a different context responsive to the system prompt selected from the playbook library.
Clause 17. The non-transitory computer-readable medium of clause 16, wherein deploying the multiple autonomous software agents comprises: deploying a first autonomous software agent to execute a first software task according to the system prompt within a first context, wherein the first context comprises a local application; and deploying a second autonomous software agent to execute a second software task according to the system prompt within a second context, wherein the second context comprises a website domain page.
Clause 18. The non-transitory computer-readable medium of any of clauses 16-17, further comprising: generating, by the second autonomous software agent, one or more artificial intelligence outputs; and pausing the second autonomous software agent from executing the second software task according to the system prompt within the second context.
Clause 19. The non-transitory computer-readable medium of any of clauses 16-18, further comprising: generating a modified system prompt by modifying the system prompt based on the one or more artificial intelligence outputs; and resuming the second autonomous software agent to execute the second software task according to the modified system prompt.
Clause 20. The non-transitory computer-readable medium of any of clauses 16-19, wherein deploying the first autonomous software agent further comprises: initializing a development session comprising an independent virtual machine computing environment hosted on a virtual private cloud and an autonomous agent model backend comprising a set of large language models; and providing a plurality of software composition tools for the first autonomous software agent to access within the independent virtual machine computing environment, wherein the plurality of software composition tools comprise a shell tool, a browser tool, an integrated development environment, and a planner tool.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multiprocessor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

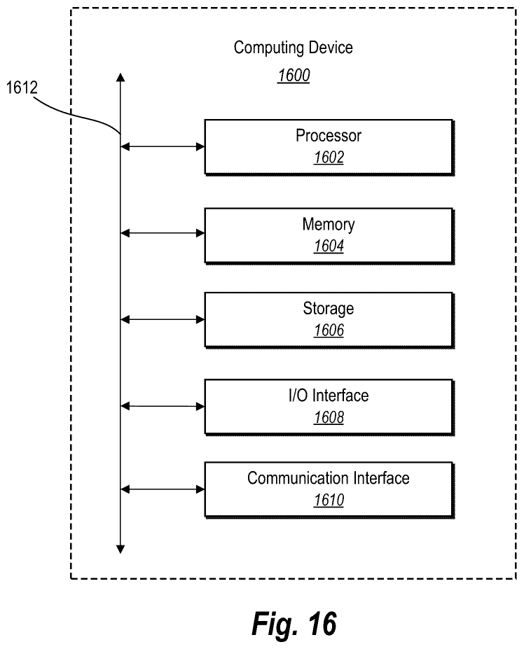

FIG. 16 illustrates a block diagram of an example computing device 1600 that may be configured to perform one or more of the processes described above. One will appreciate that one or more computing devices, such as the computing device 1600 may represent the computing devices described above (e.g., the server device(s) 1306 and/or the client device(s) 1310). In one or more embodiments, the computing device 1600 may be a mobile device (e.g., a mobile telephone, a smartphone, a PDA, a tablet, a laptop, a camera, a tracker, a watch, a wearable device). In some embodiments, the computing device 1600 may be a non-mobile device (e.g., a desktop computer or another type of client device). Further, the computing device 1600 may be a server device that includes cloud-based processing and storage capabilities.

As shown in FIG. 16, the computing device 1600 can include one or more processor(s) 1602, memory 1604, a storage device 1606, input/output interfaces 1608 (or “I/O interfaces 1608”), and a communication interface 1610, which may be communicatively coupled by way of a communication infrastructure (e.g., bus 1612). While the computing device 1600 is shown in FIG. 16, the components illustrated in FIG. 16 are not intended to be limiting. Additional or alternative components may be used in other embodiments. Furthermore, in certain embodiments, the computing device 1600 includes fewer components than those shown in FIG. 16. Components of the computing device 1600 shown in FIG. 16 will now be described in additional detail.

In particular embodiments, the processor(s) 1602 include hardware for executing instructions, such as those making up a computer program. As an example, and not by way of limitation, to execute instructions, the processor(s) 1602 may retrieve (or fetch) the instructions from an internal register, an internal cache, memory 1604, or a storage device 1606 and decode and execute them.

The computing device 1600 includes memory 1604, which is coupled to the processor(s) 1602. The memory 1604 may be used for storing data, metadata, and programs for execution by the processor(s). The memory 1604 may include one or more of volatile and non-volatile memories, such as Random-Access Memory (“RAM”), Read-Only Memory (“ROM”), a solid-state disk (“SSD”), Flash, Phase Change Memory (“PCM”), or other types of data storage. The memory 1604 may be internal or distributed memory.

The computing device 1600 includes a storage device 1606 including storage for storing data or instructions. As an example, and not by way of limitation, the storage device 1606 can include a non-transitory storage medium described above. The storage device 1606 may include a hard disk drive (HDD), flash memory, a Universal Serial Bus (USB) drive or a combination of these or other storage devices.

As shown, the computing device 1600 includes one or more I/O interfaces 1608, which are provided to allow a user to provide input to (such as user strokes), receive output from, and otherwise transfer data to and from the computing device 1600. These I/O interfaces 1608 may include a mouse, keypad or a keyboard, a touch screen, camera, optical scanner, network interface, modem, other known I/O devices or a combination of such I/O interfaces 1608. The touch screen may be activated with a stylus or a finger.

The I/O interfaces 1608 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interfaces 1608 are configured to provide graphical data to a display for presentation to a user. The graphical data may be representative of one or more graphical user interfaces and/or any other graphical content as may serve a particular implementation.

The computing device 1600 can further include a communication interface 1610. The communication interface 1610 can include hardware, software, or both. The communication interface 1610 provides one or more interfaces for communication (such as, for example, packet-based communication) between the computing device and one or more other computing devices or one or more networks. As an example, and not by way of limitation, communication interface 1610 may include a network interface controller (NIC) or network adapter for communicating with an Ethernet or other wire-based network or a wireless NIC (WNIC) or wireless adapter for communicating with a wireless network, such as a WI-FI. The computing device 1600 can further include a bus 1612. The bus 1612 can include hardware, software, or both that connects components of the computing device 1600 to each other.

In the foregoing specification, the invention has been described with reference to specific example embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel to one another or in parallel to different instances of the same or similar steps/acts. The scope of the invention is, therefore, indicated by the appended claims rather than by the foregoing description. All changes that come within the meaning and range of equivalency of the claims are to be embraced within their scope.

What is claimed:

1. A computer-implemented method comprising:
providing, for display via a graphical user interface, a playbook library comprising a plurality of reusable system prompts;
receiving, via the graphical user interface, a system prompt selected from the plurality of reusable system prompts; and
deploying an autonomous software agent, which operates within an independent virtual machine computing environment, to execute a software task responsive to the system prompt selected from the playbook library.

2. The computer-implemented method of claim 1, further comprising executing, utilizing the autonomous software agent, the system prompt comprising a procedure outlining a scope of the software task and specifications that describe post conditions of executing the software task.

3. The computer-implemented method of claim 1, further comprising executing, utilizing the autonomous software agent, the system prompt comprising forbidden actions, tips to correct actions from previous development sessions, and required user inputs to execute the software task according to the system prompt.

4. The computer-implemented method of claim 1, wherein deploying the autonomous software agent further comprises:
providing a plurality of software composition tools for the autonomous software agent to access within the independent virtual machine computing environment,
wherein the plurality of software composition tools comprise a shell tool, a browser tool, an integrated development environment, and a planner tool.

5. The computer-implemented method of claim 1, wherein receiving the system prompt further comprises:
providing, for display via the graphical user interface, an autonomous software agent chat interface; and
receiving, via the graphical user interface, guidance instructions and the system prompt selected from the plurality of reusable system prompts.

6. The computer-implemented method of claim 5, further comprising:
generating, by the autonomous software agent and utilizing a planner tool, an artificial intelligence plan based on the guidance instructions and the system prompt; and
providing, for display via the graphical user interface, a first option to modify the artificial intelligence plan or a second option to confirm the artificial intelligence plan.

7. The computer-implemented method of claim 1, wherein receiving the system prompt further comprises:
providing, for display via the graphical user interface, an autonomous software agent chat interface;
receiving, via the graphical user interface, guidance instructions, an attached file, and the system prompt selected from the plurality of reusable system prompts; and
generating, by the autonomous software agent and utilizing a planner tool, an artificial intelligence plan based on the guidance instructions and customizing the system prompt according to the attached file.

8. The computer-implemented method of claim 1, further comprising deploying multiple autonomous software agents, which operate within independent virtual machine computing environments to execute one or more software tasks each in a different context responsive to the system prompt selected from the playbook library.

9. A system comprising:
one or more memory devices; and
one or more processors coupled to the one or more memory devices, configured to cause the system to:
provide, for display via a graphical user interface, a playbook library comprising a plurality of reusable system prompts;
in response to receiving a selection of a new system prompt option, receive an additional system prompt to save in the playbook library from the graphical user interface, wherein the additional system prompt comprises a procedure outlining a scope of a software task and specifications that describe post conditions of executing the software task;
receive, from the graphical user interface, the additional system prompt selected from the plurality of reusable system prompts; and
deploy an autonomous software agent, which operates within an independent virtual machine computing environment, to execute a software task responsive to the additional system prompt selected from the playbook library.

10. The system of claim 9, wherein the one or more processors are configured to cause the system to:
provide, for display via the graphical user interface, the plurality of reusable system prompts with modification options to modify the plurality of reusable system prompts;
receive, via the graphical user interface, a selection of a modification option to modify a reusable system prompt; and
save a modified reusable system prompt to the playbook library based on the selection of the modification option.

11. The system of claim 9, wherein the one or more processors are configured to cause the system to:
provide, for display via the graphical user interface, an autonomous software agent chat interface;
receive, via the graphical user interface, guidance instructions and the additional system prompt selected from the plurality of reusable system prompts; and
customize the additional system prompt according to the guidance instructions.

12. The system of claim 9, wherein the one or more processors are configured to cause the system to:
execute, utilizing the autonomous software agent, the additional system prompt comprising a procedure outlining a scope of the software task and specifications that describe post conditions of executing the software task; and
execute, utilizing the autonomous software agent, the additional system prompt comprising forbidden actions, tips to correct actions from previous development sessions, and required user inputs to execute the software task according to the additional system prompt.

13. The system of claim 9, wherein the one or more processors are configured to cause the system to deploy the autonomous software agent by:
providing a plurality of software composition tools for the autonomous software agent to access within the independent virtual machine computing environment,
wherein the plurality of software composition tools comprise a shell tool, a browser tool, an integrated development environment, and a planner tool; and
generating, by the autonomous software agent and utilizing a planner tool, an artificial intelligence plan based on the additional system prompt.

14. The system of claim 9, wherein the one or more processors are configured to cause the system to deploy the autonomous software agent by:
initializing a development session comprising the independent virtual machine computing environment hosted on a virtual private cloud and an autonomous agent model backend comprising a set of large language models; and
transmitting, from executing the software task according to the additional system prompt, encrypted communications between the virtual private cloud that hosts the independent virtual machine computing environment and the autonomous agent model backend.

15. The system of claim 9, wherein the one or more processors are configured to cause the system to:
deploy the autonomous software agent, which operates within the independent virtual machine computing environment, to execute the software task responsive to the additional system prompt in a first software context; and
deploy an additional autonomous software agent, which operates within an additional independent virtual machine computing environment, to execute an additional software task responsive to the additional system prompt in a second software context.

16. A non-transitory computer-readable medium storing executable instructions which, when executed by at least one processing device, cause the at least one processing device to perform operations comprising:
providing, for display via a graphical user interface, a playbook library comprising a plurality of reusable system prompts;
receiving, from the graphical user interface, a system prompt selected from the plurality of reusable system prompts; and
deploying multiple autonomous software agents, which operate within independent virtual machine computing environments to execute one or more software tasks each in a different context responsive to the system prompt selected from the playbook library.

17. The non-transitory computer-readable medium of claim 16, wherein deploying the multiple autonomous software agents comprises:
deploying a first autonomous software agent to execute a first software task according to the system prompt within a first context, wherein the first context comprises a local application; and
deploying a second autonomous software agent to execute a second software task according to the system prompt within a second context, wherein the second context comprises a website domain page.

18. The non-transitory computer-readable medium of claim 17, further comprising:
generating, by the second autonomous software agent, one or more artificial intelligence outputs; and
pausing the second autonomous software agent from executing the second software task according to the system prompt within the second context.

19. The non-transitory computer-readable medium of claim 18, further comprising:
generating a modified system prompt by modifying the system prompt based on the one or more artificial intelligence outputs; and
resuming the second autonomous software agent to execute the second software task according to the modified system prompt.

20. The non-transitory computer-readable medium of claim 17, wherein deploying the first autonomous software agent further comprises:
initializing a development session comprising an independent virtual machine computing environment hosted on a virtual private cloud and an autonomous agent model backend comprising a set of large language models; and
providing a plurality of software composition tools for the first autonomous software agent to access within the independent virtual machine computing environment,
wherein the plurality of software composition tools comprise a shell tool, a browser tool, an integrated development environment, and a planner tool.
